(19) United States
(12) Patent Application Publication
(10) Pub. No.: US 2016/0117740 A1
(43) Pub. Date: Apr. 28, 2016

(54) REMARKETING PRODUCTS TO SOCIAL NETWORKING SYSTEM USERS

(71) Applicant: Facebook, Inc., Menlo Park, CA (US)

(72) Inventors: Lee Charles Linden, San Francisco, CA (US); Benjamin Lewis, San Francisco, CA (US); Dwight Ewing Crow, San Francisco, CA (US); Jonathan Shottan, San Francisco, CA (US); Peng Fan, Castro Valley, CA (US)

(21) Appl. No.: 14/524,335

(22) Filed: Oct. 27, 2014

(51) Int. Cl. G06Q 30/02; G06Q 50/00

(52) U.S. Cl. CPC G06Q 30/0277; G06Q 30/0269; G06Q 50/01

(57) ABSTRACT

The present disclosure relates, in part, to an advertisement system that provides for the remarketing of products to a user within a social networking system. More specifically, the advertisement system can analyze a user's social networking profile, which can include information derived from user activity related to third-party content, to identify the user's interest in and/or association with a product previously marketed to the user. Using the user's social networking profile, the advertisement system can create a customized advertisement for the user for a product previously, marketed to the user and serve the customized advertisement to the user within the social networking system.

### BACKGROUND

1. Technical Field

One or more embodiments relate generally to an online social networking system. More specifically, one or more embodiments relate to remarketing products to social networking system users.

2. Background and Relevant Art

A social networking system allows its users to connect to and communicate with other social networking system users. Each user may create a profile on a social networking system that corresponds to a user identity and may include information about each specific user, such as interests and demographic information. Because of the increasing popularity of social networking systems, as well as the increasing amount of user-specific information to which a social networking system has access, a social networking system may provide an ideal forum for advertisers to increase awareness about products or services.

Generally, advertisers may include third-party merchants (e.g., entities separate from the provider of a social network system). Many advertisers provide merchant content (e.g., web sites, applications) to promote and sell products and/or services outside of the social networking system. Advertisers may desire to advertise to users within a social networking system to drive more user traffic to view and purchase the merchant content. For example, presenting advertisements to users within a social networking system can allow an advertiser to gain increased public awareness for its products and/or services.

Conventionally, an advertiser can track an individual user's activity with respect to the advertiser's content (e.g., web site, application), however, the advertiser generally lacked any additional information about the user that would be helpful in advertising products to the user, or to other potential customers, based on activity of an individual user. More often than not, an advertiser's best method of following up with a user based on the individual user's activity with respect to merchant content is sending a follow-up communication to the individual user, assuming the advertiser has an email address or physical address for the user. Therefore, the advertiser's follow-up activities are often inefficient, limited in nature, and lack accurate targeting to customers.

In contrast to an individual advertiser, a social networking system can include a wealth of information associated with known specific users. Conventional advertising systems and social network systems, however, have no way of correlating user activity related to merchant content with a known user of a social networking system. Traditionally, therefore, the targeting accuracy of a merchant's advertising efforts within a social networking system is limited. For example, although targeted advertising is possible within the social networking system, the targeted advertising may be limited to only user information provided and collected within the social networking system itself. Therefore, conventional targeted advertisement efforts does not account for user activity that takes place outside the social networking system.

Accordingly, there are a number of disadvantages with conventional methods of providing remarketed advertising to users of a social network.

### SUMMARY

One or more embodiments described herein provide benefits and/or solve one or more of the foregoing or other problems in the art with systems and methods for using social networking profiles for remarketed advertising. For example, one or more embodiments include systems and methods of maintaining a social networking profile for a user based on social networking activity within the social networking system. Additionally, the systems and methods may also collect third-party content activity data generated in response to the user interacting with third-party content (e.g., web sites and applications outside of the social networking system). In one or more embodiments, the systems and methods augment the user's social networking profile with the third-party activity data to reflect interests and characteristics (e.g., products a user views and/or buys) specific to the user. The system advertisement methods can also use the social networking profile (or simply “user profile”) of the user to remarket products to the user as part of a remarketing campaign. For example, the systems and methods can remarket one or more products with which the user indicated a level of interest while interacting with the third-party content.

In particular, the user profile can provide a unified representation of the user's activities within the social networking system as well as the user's activities with third-party content. For example, in one or more embodiments, the user profile can identify a specific product or type of product in which the user has expressed an interest based on activity within the social networking system, activity with third-party content, or both. In some embodiments, the systems and methods can use the user profile and/or the identified product to provide improved remarketing to the user while the user is interacting within the social networking system.

More specifically, the systems and methods can use the user profile of a user to provide remarketing of identified products to the user. For example, a user can interact with third-party content associated with a product, and then at a later time, the systems and methods cause the social networking system to provide the user with an advertisement related to the identified product. Alternatively, or additionally, the social networking system can provide the user with an advertisement for different versions of the product the user viewed on the third-party content, such as the product in a different color, in a bundle with other products, or an upgraded or downgraded version of the product. Thus, the systems and methods described herein allow a social networking system to remarket products with which a user interacted by way of third-party content.

Furthermore, the systems and methods disclosed herein can provide for remarketing to a dynamic audience. For example, when a user shows a particular product in association with third-party content, the social networking system can update (e.g., add, remove, augment, etc.) the social networking profile of the user. Then, when the third-party desires to remarket the product to users of the social networking system, the systems and methods disclosed herein can provide for the creation a dynamic audience that includes users who have expressed interest in the product. In addition, users of the social networking system can be added and removed from a dynamic audience as their interest in the product changes.

Moreover, in one or more embodiments, the systems and methods can provide customized advertising for a product on a per user basis for users in a dynamic audience. In particular, the one or more embodiments disclosed herein provide for personalizing and customizing advertisements for the same product on per user level using the user profiles of each user in the dynamic audience. For example, for each user of the dynamic audience, the systems and methods disclosed herein can identify one or more user characteristics from the user's user profile that increase the probability that the user will make a product purchase (i.e., lead to a product conversion). Alternatively, the systems and methods disclosed herein can generate and serve multiple customized advertisements for a product to a user to identify which characteristics are favored by the user. The systems and methods can then update the user's user profile based on the identified user characteristics.

Additional features and advantages of the embodiments will be set forth in the description that follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots) are used herein to illustrate optional features or operations that add additional features to embodiments of the disclosure. Such notation, however, should not be taken to mean that these are the only options or optional operations, and/or that blocks with solid borders are not optional in certain embodiments of the disclosure. Understanding that these drawings depict only typical embodiments of the disclosure and are not therefore to be considered limiting of its scope, the disclosure will be described and explained with additional specificity and detail through the use of the accompanying drawings in which:

FIG. 1 illustrates a schematic diagram of a product remarketing system using one or more embodiments of an advertisement system as disclosed herein;

FIG. 2 illustrates a schematic diagram of an advertisement system in accordance with one or more embodiments;

FIG. 3 illustrates a detailed schematic diagram of an advertisement system in accordance with one or more embodiments;

FIG. 4 illustrates a schematic diagram of an example third-party web site in accordance with one or more embodiments;

FIG. 5 illustrates a process flow diagram of providing a remarketing advertisement in accordance with one or more embodiments;

FIG. 6 illustrates a graphical user interface including an example target audience form in accordance with one or more embodiments;

FIG. 7 illustrates a graphical user interface including an example product advertisement form in accordance with one or more embodiments;

FIG. 8 illustrates a flowchart of an exemplary method for remarketing a product to a dynamic audience on a social networking system in accordance with one or more embodiments;

FIG. 9 illustrates a flowchart of another exemplary method for remarketing a product to a dynamic audience on a social networking system in accordance with one or more embodiments;

FIG. 10 illustrates a block diagram of an exemplary computing device in accordance with one or more embodiments; and

FIG. 11 is an example network environment of a social networking system in accordance with one or more embodiments.

### DETAILED DESCRIPTION

One or more embodiments of the present disclosure relate to an advertisement system that includes systems and methods for remarketing products to a user within a social networking system based on the user's social networking profile, which includes information derived from user activity related to third-party content. For example, the third-party content may include web sites, applications, application data, and various other third-party content sources that are outside the social networking system. The advertisement system can use user profiles belonging to users of a social networking system to provide effective remarketing advertising to the users based on the users' activity related to third-party content, as well as the users' activity within the social networking system. For example, the advertisement system can remarket products within the social networking system based on products a user views outside of the social networking system. One or more embodiments of an advertisement system can include various methods of analyzing and/or processing the user's user profile to provide effective and accurate targeted remarketing advertising to the user within the social networking system.

More particularly, one or more embodiments of the advertisement system may allow for the tracking of a user's interactions with third-party content related to a product. For example, upon a user interacting with third-party content related to a product on a client device, the client device may send the social networking system a product identifier associated with the product and, in some cases, a user identifier associated with the user. Third-party content interactions may include, for example, the user viewing the product on a web site, filling out a survey about the product, placing the product in a shopping cart, and/or purchasing the product. The social networking system can use the product identifier and the user identifier to update the user's social networking profile to reflect the user's demonstrated level of interest in the product.

In contrast to conventional techniques and methods, one or more embodiments of the advertisement system allow user activity related to third-party content to be combined with user activity within a social networking system. In particular, the advertisement system can combine known user information from a user's social networking profile (e.g., name, demographic information), social networking activity data (e.g., contacts (e.g., “friends”), likes, comments, clicks, groups, geographic location), and third-party content activity data of a user. The combination of user information, social networking activity data, and third-party content activity data provides an information rich profile for each user of the social networking system that may take into account a significant portion of a user's online activity. Therefore, the advertisement system can use the user profile to provide customized remarketing advertisements to users, creating more efficient and successful advertising results.

In addition, the advertisement system allows an advertiser the ability to know additional information about a user that interacted with one or more merchants' third-party content, such as a merchant associated with the advertiser or a competing merchant. For example, one or more embodiments of the advertisement system can correlate a user's activity with third-party content. In addition, the advertisement system can correlate a user's activity on third-party content with user characteristics and/or social networking activity of the user. Thus, compared to conventional systems, the advertisement system provides advertisers the ability to not only identify users that have interacted with a advertisers' third-party content, but also provides advertisers additional information about users that may be helpful in determining how to best remarket products to potential customers.

In one or more embodiments, the advertisement system can use the user profile of a user to provide targeted remarketing advertisements to the user after the user interacts with third-party content (e.g., viewing or selecting one or more products). For example, one or more embodiments of an advertisement system allow for remarketing a specific product to a user. In particular, the advertisement system can use a user's user profile to determine if the user is interested in the specific product based on the user's interaction with third-party content (e.g., viewing product information on a merchant's web site). Subsequently, the advertisement system can provide a remarketing advertisement for the specific product to the user by way of a social networking system.

Moreover, example embodiments of the advertisement system can analyze a user profile to determine one or more other product versions in which the user may be interested. For example, in one or more embodiments, the advertisement system can identify a product from the user profile of a user. The advertisement system can use the user profile to identify a version of the product tailored to the user. For example, the advertising system can identify an upgraded or downgraded version of the product. Additionally or alternatively, the advertising system can identify the product offered in a different color, such as a color preferred by the user. After identifying the product variation, the advertisement system can provide an advertisement for the product variation to the user.

In one or more embodiments, the advertising system can remarket products to users of the social networking system using a dynamic audience. For example, using the profiles of users of the social networking system, the advertising system can create a dynamic audience that includes users that have expressed interest in a product (e.g., viewed the product on the social networking system or a third-party website). Further, a user can be added or removed from a dynamic audience when the user's interest with the product changes. For example, the advertising system can remove a user from a dynamic audience for a product when the user purchases the product. Further, if a period of time passes since a user last shows interest in a product, the advertising system can remove the user from a dynamic audience for the product. As another example, the advertising system can add a user to a current dynamic audience for a product when a user, not yet in the dynamic audience, shows interest in the product.

In some example embodiments, the advertising system can generate customized product advertisements for users in a dynamic audience. In particular, the advertising system can generate multiple advertisements for a product and provide the product advertisements to users in the dynamic audience. For example, the advertising system can serve an advertisement for a product to one or more members of a dynamic audience. The advertising system can then serve another advertisement for the product to other members of the dynamic audience. Thus, the advertising system can serve different advertisements for the same product to users in a dynamic audience based on the users individual user preferences. In some embodiments, the advertising system can generate an advertisement for each member of the dynamic audience based on the user profile of each user. In this manner, the advertising system can maximize the probability that each user in a dynamic audience will select an advertisement for the remarketed product.

In some example embodiments, the advertising system can customize product advertisements to determine additional attributes and characteristics about users. For example, the advertising system can create a variety of remarketing advertisements for a product. The advertising system can provide two or more advertisements to a user. Based on the user's interaction with each advertisement, the advertising system can identify user preferences. For example, the advertising system can identify that a user prefers a particular product color or style. In addition, the advertisement system may determine that a user is more likely to click on an advertisement that does not show a product description and/or price in the advertisement. Using the identified preference, the advertising system can update the user's user profile. The advertising system can then use the identified preference to customize future product advertisements for the user.

Additionally, in one or more embodiments, the advertisement system can analyze a user profile to determine whether a user interacted with a product using a first computing device, such as a smartphone. The advertisement system may then determine, based on information associated with the user, a second computing device (e.g., a laptop or desktop computer, etc.) associated with the user. In one or more embodiments, when the user connects to the social networking system using the second computing device, the advertisement system can deliver a remarketing advertisement associated with the product to the second computing device of the user.

As a more specific example, in one or more embodiments, an advertisement system can analyze a user profile and determine that a user started a purchasing process for a product on the first computing device, but did not complete the purchase. In particular, some users may be more likely to make a purchase on a desktop or laptop, compared to making a purchase on a smartphone. At a later time, the advertisement system may detect that the user is present on a second computing device, and deliver a remarketing advertisement to the second computing device with a link to a landing page through which the user may complete the purchase of the product.

The advertisement system's ability to deliver cross-device remarketing advertisements based on a user profile, as generally described above, provides a more effective remarketing advertisement opportunity compared to conventional methods and systems. Furthermore, a remarketing advertisement can serve as a reminder to the user to purchase the product in which the user indicates an interest.

As used herein, the term “marketing” refers to advertising content associated with a particular product to a user. In some embodiments, a product may be marketed to a user over a communication network, on a third-party web site or application, or by way of a social networking system. Additionally, the term “remarketing” refers to advertising or marketing a product to a user after the product or a related product has been previously marketed to the user, or if the user's past activities indicate an interest in the product or a related product. For example, if a user's actions indicate interest in a product, but the user does not purchase the product, the advertising system can remarket the product to the user. Alternatively, the advertising system can remarket a product to a user after a period of time has passed since the user last purchased the product.

In addition, as used herein, the term “content” refers to any form of digital data that may be transmitted over a communication network. For example, content can include, but is not limited to, web sites, web pages, digital media (e.g., audio, video, images), electronic documents, electronic messages, or any other digital content or combination of digital content. In addition, the term “third-party content” refers to content that is provided by a content source that is outside of a social networking system. For example, third-party content may include content associated with a product offered by a third-party merchant.

The term “product,” as used herein, may refer to a good or service provided by one or more advertisers (e.g., merchants). For example, a product can refer to a tangible good. Alternatively, or in addition, a product can refer to a service or other intangible product.

As used herein, the term “dynamic audience” refers to an audience or group of one or more users of a social networking system that are dynamically identified and/or updated for the purposes of remarketing one or more products. For example, a dynamic audience can be a group of social networking users that each conducted some activity associated with a product within a particular time period. For instance, as described above, when a user's actions indicate interest in a product, the advertising system can update (e.g., add to, modify, augment, etc.) the user's social networking profile to indicate the user's interest in the product. The advertising system can identify the user's interest in a product and include the user in a dynamic audience associated with the product. In addition, a user can be included in a number of dynamic audiences. Further, users can be added or removed from a dynamic audience, as described in more detail herein.

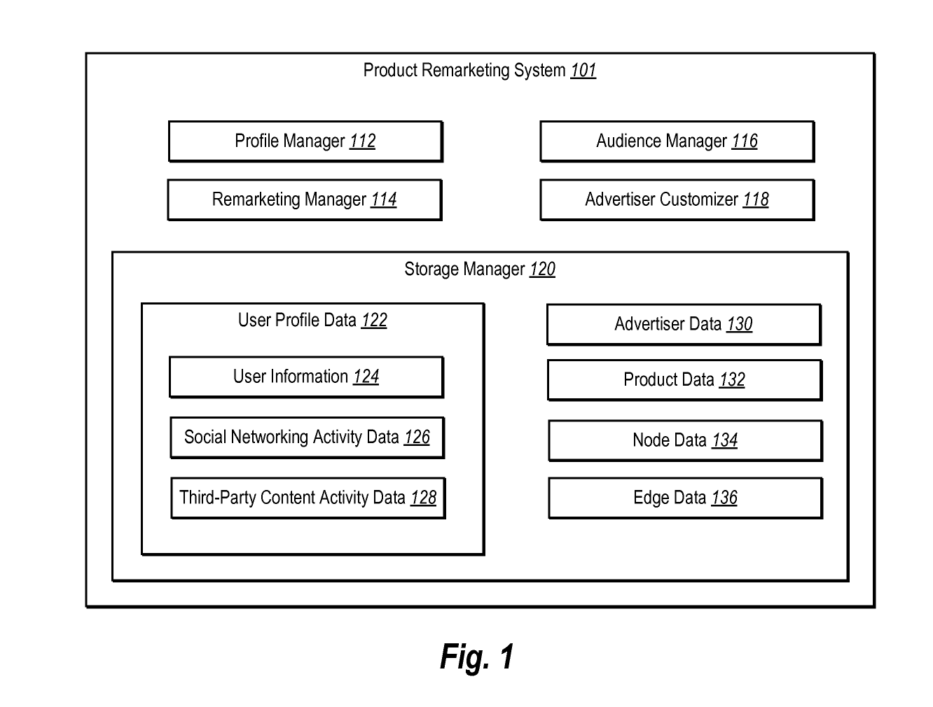

FIG. 1 illustrates a schematic diagram of a product remarketing system 101 in accordance with one or more embodiments. As shown, the product remarketing system 101 can include various components for performing the processes and features described herein. For example, in the illustrated embodiment, the product remarketing system 101 may include a profile manager 112, a remarketing manager 114, a dynamic audience manager 116, an advertisement customizer 118, and a storage manager 120. The storage manager 120 can store user profile data 122, advertisement data 130, product data 132, node data 134, and edge data 136, as will be explained in more detail below.

Each component of the product remarketing system 101 may be implemented using a computing device including at least one processor executing instructions that cause the product remarketing system 101 to perform the processes described herein. In some embodiments, the components of the product remarketing system 101 can all be implemented by a single server device, or across multiple server devices. Although a particular number of components are shown in FIG. 1, the product remarketing system 101 can include more components or can combine the components into fewer components (such as a single component), as may be desirable for a particular implementation.

The profile manager 112 can manage one or more user profiles (e.g., social networking profile for users). For example, as described above, each user in a social networking system can be associated with a user profile. In managing user profiles, the profile manager 112 can access and/or manage user profile data within each user profile.

In one or more embodiments, a user profile may include, but is not limited to, user information 124, social networking activity data 126, and third-party content activity data 128. User information 124 can include personal information about a user (e.g., name, gender, age, birth date, hometown, etc.), contact information (e.g., residence address, mailing address, current city, email addresses, phone numbers, screen names, etc.), educational information (e.g., school, highest schooling level obtained, time period, class year, concentration, degree, etc.), employment information (e.g., employer, position, employer locations, employment history, etc.), family and relationship information (e.g., married to, engaged to, partners with, parents of, siblings of, children of, cousin of, relationship with, etc.), and any other type of personal or demographic information.

The social networking activity data 126 can include data associated with a user's activity within a social networking system. For example, in one or more embodiments, the social networking activity data 126 can include user actions (e.g., likes, page visits, games played, posts created, posts read, comments, clicks, groups, interest lists, etc.), social connections (e.g., “friends,” groups, following, members of, connections, communications, etc.), tags (e.g., tags of the user in photos, videos, posts, etc.), applications used by the user on the social networking system, and other social networking activity data as described herein.

The third-party content activity data 128 can include data that corresponds to the user's activity with respect to content outside of the social networking system. For example, the third-party content activity data 128 can correspond to a user's interactions on a third-party advertiser and/or merchant web site. For instance, the third-party content activity data 128 can include page views, purchases, additions to a shopping cart, and/or any other user activity with respect to third-party content. The third-party content activity data 128 may also indicate interests in categories, products, brands, colors, prices, etc. Further, the third-party content activity data 128 can include levels of interests, such as if a user views, selects, or adds a product to a shopping cart (e.g., a virtual shopping cart).

In some example embodiments, the third-party content activity data 128 includes data from multiple third-party merchants. For example, a social networking user may be viewing or comparing a specific product (e.g., headphones) on a number of merchant web sites. Accordingly, the third-party content activity data 128 may include information from each of the merchant web sites. Further, the third-party content activity data 128 may include the total time the user views the product on each site, or total time viewing the product. The third-party content activity data 128 can be used to determine, based on the number of sites the user viewed the product on and the time the user spent looking at the product, the interest level of the user in the product.

In one or more embodiments, the product manager 112 can update (e.g., supplement, add, remove, modify, augment, etc.) information within a user profile. For example, the product manager 112 can receive third-party content activity data 126 from a third-party merchant corresponding to a user's interest in merchant content, such as a product. To illustrate, a third-party merchant can send third-party content activity data 126 including a content ID and a user ID corresponding to the user's activity on the merchant's web site. The product manager 112 can use the user ID to identify a user within the social networking system. In addition, the product manager 122 can use the content ID to identify a product. The product manager 122 can then update a user profile for the user based on the identified information. For example, the product manager 112 can use the content ID to look up product data 132, stored by the storage manager 120, such as a product name, product type, brand, model, color, etc. Then, the product manager 112 can update the user profile of the identified user with the product information. In addition, the product manager 112 can update the user profile to include the date and time the user interacted with the third-party content, the client device that the user was using to interact with the third-party content, and details about the user interaction (e.g., browsing activity, shopping cart activity, purchasing activity, etc.).

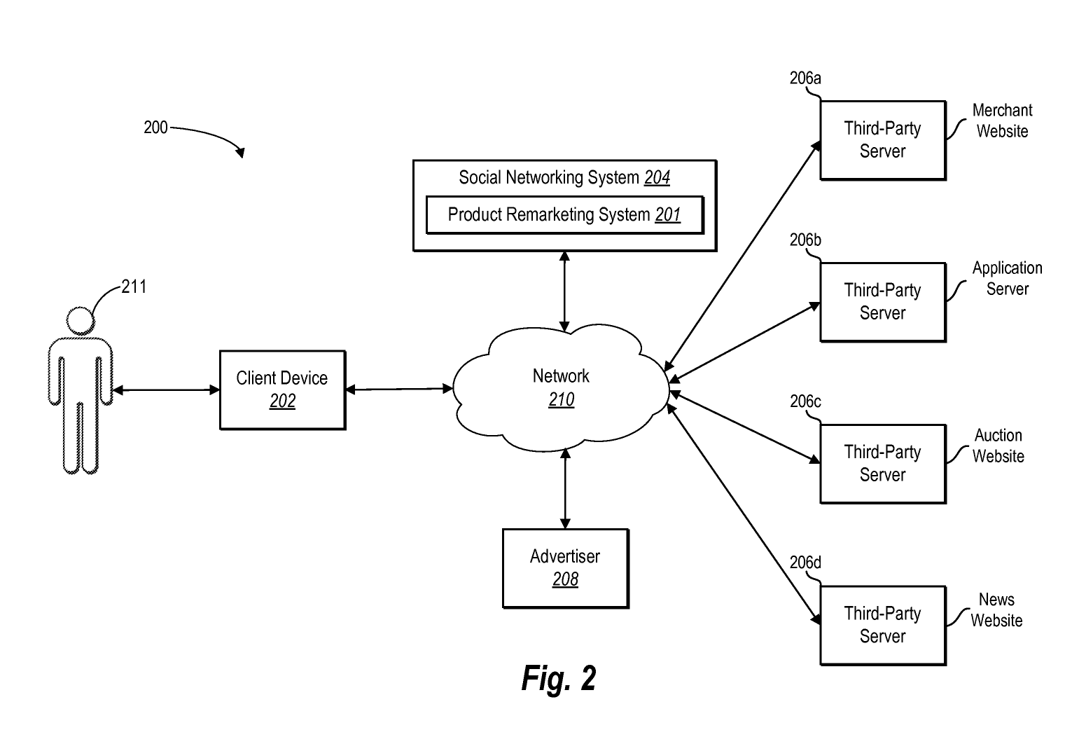

Further, as the user continues to interact within the social networking system, the product manager 112 (or another similar component within the product remarketing system 101) can continue to update the social networking activity data 126 associated with the user. Similarly, and in addition to activity within the social networking system, the product manager 112 can continue to update the third-party content activity data 128 with information associated with the third-party content when a user interacts with content outside of the social networking system. Additional detail regarding tracking and updating user profile data 122 is given below in connection to FIGS. 2-4.

Therefore, over time, the product manager 112 updates the user profile data 122 for each user of the social networking system with a wealth of user activity data including both social networking activity data 126, as well as third-party content activity data 128. Moreover, the profile manager 112 can associate the activity data with user information 122, so that in many or most cases, an actual user identity, with known user characteristics, is associated with activity data.

In some example embodiments, the product manager 112 can update the third-party content activity data 128 to include third-party offline activity of a user. For example, a user may carry a GPS enabled device (e.g., smartphone, tablet, camera, tracker, watch, etc.) that reports the user's location, such as when a user is at a location associated with a third-party (e.g., a shopping center, store, point of interest, museum, school, etc.). The profile manager 112 can then update the third-party content activity data 128 to reflect the user's physical patterns (e.g., the number of times a user visits a merchant, the time the user's stays, the frequency of visits, whether a users commutes past a merchant, etc.).

Using the user profile data, the profile manager 112, in cooperation with one or more third-party advertisers, can access, analyze, and otherwise use the user profiles (i.e., the user profile data 122) to provide effective remarketing to users of the social networking system 204. For example, the profile manager 112 can identify, from a user's user profile data 122, if the user has shown interest in a specific product, and if so, the level of interest the user has shown in the specific product.

As mentioned above, product remarketing system 101 may include a remarketing manager 114. The remarketing manager 114 can receive one or more remarketing campaign requests. In particular, an advertiser may request a remarketing campaign on a social networking system for one or more of the advertiser's products. For example, an advertiser may request that the social networking system remarket one or more of the advertiser's products to users of the social networking system to users for whom the social networking system has previously detected interest in the product (e.g., when the product was previously marketed to them). The remarketing manager 114 may store information related to remarketing request as advertisement data 132 within the storage manager 120.

In one or more embodiments, the remarketing manager 114 can look up product data 132 for the product(s) identified in a remarketing request. For instance, the advertiser may have previously sent product information, stored as product data 132, to the product remarketing system 101. Accordingly, the remarketing manager 114 can access the stored product data 132 to obtain additional information regarding products, as described above.

In some example embodiments, the remarketing manager 114 can establish parameters of a remarketing campaign as set by an advertiser. For example, in the remarketing request, the advertiser can include which product(s) to remarket, the length of time the remarketing campaign should last, the budget constraints of the campaign, the target audience(s) of the campaign, the focus the remarketing campaign, etc. Alternatively, the remarketing manager 114 may obtain the parameters for a marketing campaign after receiving the remarketing request. For example, after receiving the remarketing request, the remarketing manager 114 can provide the advertiser with a list of selectable options that allows the advertiser to set parameters for a remarketing campaign. Additionally, or in another alternative, the remarketing manager 114 can use default parameters for a remarketing campaign, such as default parameters set by each advertiser or general parameters set by the remarketing manager 114. For example, default parameters can be stored as advertisement data 132 in the storage manager 120.

In one or more embodiments, the remarketing manager 114 can provide feedback to an advertiser during a remarketing campaign. The remarketing manager 114 can provide information regarding active remarketing campaigns as well as past or future remarketing campaigns. For example, the remarketing manager 114 can provide statistics (e.g., advertisements served, clicked, converted, etc.) about a remarketing campaign to the advertiser. Information corresponding to advertisements can be stored and retrieved from advertisement data 132 located in the storage manager 120. The remarketing manager 114 can also indicate which parts of a remarketing campaign are currently successful and/or unsuccessful, as described below in additional detail.

In some example embodiments, the remarketing manager 114 can allow an advertiser to modify a current or future remarketing campaign. For example, an advertiser can decide to increase the number of remarketing advertisements to a particular group of users within the social networking system. For instance, the remarketing manager 114 may indicate that mothers with school age children are more likely to click on a remarketed advertisement for school supplies than any others users who have also previously showed interest in school supplies. In response, the advertiser may modify the remarketing campaign to serve more school supply advertisement to mothers with school age children than to other users targeted in the remarketing campaign. Similarly, based on feedback received from the remarketing manager 114 concerning a current remarketing campaign, the advertiser can change parameters for other remarketing campaigns.

The remarketing manager 114, in one or more embodiments, can provide advertisements to users within a social networking system. In particular, the remarketing manager 114 can serve advertisements as part of a remarketing campaign to client devices associated with users of a social networking system. Further, the remarketing manager 114 can serve different advertisements for a single product within a remarketing campaign. For example, the remarketing manager 114 can serve one advertisement for a product to one user, while serving a different remarketing advertisement for the same product to another user, as part of the same remarketing campaign.

The remarketing manager 114 can also monitor a user's response to a remarketing advertisement. For example, the remarketing manager 114 can identify if a user responds positively, negatively, or is unresponsive to a remarketed product advertisement. Monitoring can occur within the social networking system, or outside the social networking system, as described above. In addition, the remarketing manager 114 can determine if a user prefers one type of advertisement to another type of advertisement. Monitoring users' reaction to product advertisements in a remarketing campaign is described below in additional detail.

As mentioned above, the product remarketing system 101 may include an audience manager 116. The audience manager 116 can manage dynamic audiences of users in the social networking system. In particular, the audience manager 116 can create, modify, update, or delete a dynamic audience. In addition, the audience manager 116 can add or remove users from a dynamic audience for a product as user interest in the product changes.

As described above, a dynamic audience can include one or more social networking users that have showed some level of interest in one or more products being remarketed (e.g., the user has been marketed the product previously). Further, a user can be included in multiple dynamic audiences. For example, a user who often shops online and views numerous products can be included in a number of dynamic audiences. Alternatively, a user may not be included in any dynamic audiences.

In one or more embodiments, the audience manager 116 can create a dynamic audience upon receiving a remarketing request. For example, as described above, the remarketing manager 114 can receive a remarketing request from an advertiser that includes a request to execute a remarketing campaign for one or more products. The audience manager 116 may then create one or more dynamic audiences that include users for whom the audience manager 116 has previously detected an interest in the one or more products in conjunction with the advertiser. In addition, or in another embodiment, the dynamic audience can include users that have expressed interest in the product while interacting on other third-party web sites, such as a competitor's web site.

Membership in a dynamic audience can be further based on parameters of a remarketing campaign. In particular, the audience manager 116 can customize membership in the dynamic audience by applying filters to the dynamic audience. For example, in addition to a user's interest in the one or more product identified in the remarketing request, an advertiser may request to target user who are within a specific age range, location, employment field, etc. Additional detail regarding filtering social networking users in a dynamic audience is provided below.

In some example embodiments, the dynamic audience can be associated with an advertiser. For example, a dynamic audience can be created upon receiving a request from an advertiser for a remarketing campaign. In one embodiment, a dynamic audience can include users that have expressed interest in a product on the advertiser's web site (e.g., a merchant web page associated with the advertiser) or who will express interest in the product during the remarketing campaign. Further, the advertiser may define membership filters to users in a dynamic audience according to their preferences for a remarketing campaign with which the advertiser is involved.

Alternatively, in some example embodiments, the dynamic audience can correspond to a product irrespective of whether an associated remarketing campaign exists. For example, each product may correspond to a dynamic audience. Then, when an advertiser requests a remarketing campaign for the product, the audience manager 116 can use the existing dynamic audience associated with a product the advertiser requested to remarket. Further, the audience manager 116 can narrow the number of users in a dynamic audience when an advertiser requests customization of a dynamic audience (e.g., filter membership in a dynamic audience). In addition, the audience manager 116 can increase the number of users in a dynamic audience when an advertiser desires to add two existing dynamic audiences together, such as requesting a remarketing campaign involving users for whom the audience manager 116 has detected an interest in either product x or product y.

In addition to the above, the audience manager 116 can use a scoring process when identifying users that may have an interest in a particular remarketing advertisement to include in a dynamic audience. For example, the audience manager 116 can compare a user profile with a baseline, and then calculate a score or rank that correlates with the likelihood the user is interested in a particular product. In one or more embodiments, the audience manager 116 can determine the top one-thousand (or other predefined number) of users that indicate the strongest interest in a particular product to include in a dynamic audience for the product. In this way, the advertiser 108 can use the product remarketing system 101 to provide a remarketing advertisement to a defined group of users that have the strongest interest in the merchant's product.

Although the audience manager 116 can analyze user profiles at a particular instance in time to determine a dynamic audience, the audience manager 116 can also continue to analyze user profiles to identify users that may not have demonstrated an interest in a particular product at a first period of time, but later demonstrated an interest in the product based on additional user activity with respect to social networking content and/or third-party content. For example, if the user's activity indicates an interest in a product for which there is a dynamic audience, the user can be added to the dynamic audience, as described above.

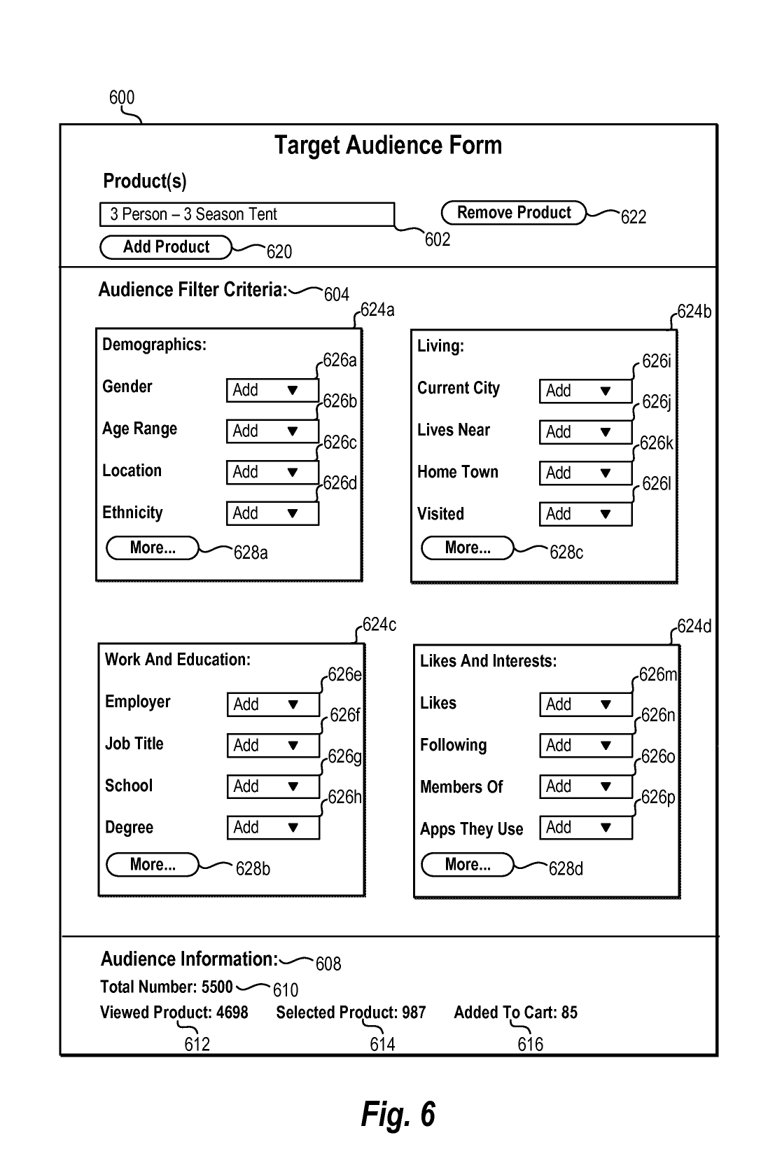

In one or more embodiments, upon creating a dynamic audience, the audience manager 116 can identify information corresponding to the dynamic audience. For example, the audience manager 116 can identify the number of users in the dynamic audience (e.g., the number of users who have a detected interest in the product) and/or personal (e.g., demographic) information associated with the users in the dynamic audience. The audience manager 116 can provide this number to the advertiser. Further, when an advertiser modifies parameters of a remarketing campaign (e.g., filters the number of users in a dynamic audience), the audience manager 116 can provide the updated numbers of users in the dynamic audience to the advertiser, for example, as the advertiser adds and removes audience filter criteria, as described below in conjunction with FIG. 6.

In some example embodiments, the audience manager 116 can identify groups within a dynamic audience. For example, the audience manager 116 can identify groups according to interest level in a product. For instance, if a dynamic audience includes users who have a detected interest in a product, the audience manager 116 can identify groups (e.g., interest groups) of users between users who viewed the product in a general category, viewed the product page, interacted with the product page (e.g., selected a “read more” option on the product page), compared the product with other products, commented on the product, shared the product with other users, added the product to a virtual shopping cart, purchased the product, etc. A user may be included in one or more product interest groups (e.g., a user both viewed the product page and added the product to a shopping cart). Alternatively, a user may belong only to the product interest group for which he or she showed the highest level of interest (e.g. a user that added the product to a shopping cart does not belong to the group associated with the user viewing the product page).

The audience manager 116 can provide the number of users in each group to the advertiser. As the advertiser selects, deselects, and/or otherwise modifies parameters for their remarketing campaign, the number of users in each group provided to the advertiser can update be updated by the audience manager 116. In addition, the audience manager 116 can assist the advertiser in narrowing the number of users in a dynamic audience by only including users who meet or exceed a threshold interest level in the product (e.g., target only users who added the product to a shopping cart). Further, the audience manager 116 can allow the advertiser to divide the focus of a remarketing campaign among the different interest groups. For example, the advertiser may request to concentrate the majority of a remarketing campaign on users who have recently added a product (e.g., a drill) to a shopping cart while reducing focus to users who have only viewed a category (e.g., hardware) associated with the product.

In some example embodiments, the audience manager 116 can provide feedback regarding characteristics and attributes of users in a dynamic audience to an advertiser. For example, the audience manager 116 may identify that the majority of users in a dynamic audience share a common attribute. For example, the audience manager 116 can identify that 70% of users in a dynamic audience prefer products that are the color red, or prefer products associated with the outdoors. Similarly, the audience manager 116 can identify unfavorable attributes associated with one or more users in a dynamic audience, such as disliking a particular style.

As briefly described above, the product remarketing system 101 can include an advertisement customizer 118. The advertisement customizer 118 can generate customized advertisements for one or more users in a dynamic audience as part of a remarketing campaign. For example, the advertisement customizer 118 can obtain product information for a product from the product data 132 in the storage manager 120. Further, the advertisement customizer 118 can receive user profile data 112 regarding users in a dynamic audience from the profile manager 112 and/or user profile information 122, and customize an advertisement for one or more users in the dynamic audience based on the received information.

In one or more embodiments, the advertisement customizer 118 can receive input from an advertiser regarding which content to include and/or exclude from an advertisement. For example, the advertisement customizer 118 can receive input, for instance, in the remarketing request for a product, to emphasize a specific benefit associated with the product. Additionally or alternatively, in some embodiments, the advertisement customizer 118 can obtain product information to include in advertisements from product data 132 or a product node associated with the product, as described below.

As a specific example, an advertiser may request the product remarketing system 101 remarket a number of products, such as a polo shirt. The audience manager 114 can create a dynamic audience based on users who have a detected interest in the polo shirt (e.g., users who have been marketed or have otherwise interacted with the polo shirt previously). Using user profile data 122 associated with users in the dynamic audience, the advertisement customizer 118 can create a number of advertisements marketing the polo shirt or versions of the polo shirt. For instance, the advertisement customizer 118 can create an advertisement showing a yellow polo shirt, a striped polo shirt, a white polo shirt, a group of polo shirts in different colors, a polo shirt with a sports team patch, a polo shirt with a pocket, etc., based on individual preferences of users in the dynamic audience. Further, the advertisement customizer 118 can provide advertisements with long descriptions, advertisements with a short description or only a product title, advertisements not showing a price, etc. Thus, the advertisement customizer 118 can tailor each advertisement based in part on user profile data 122 for each user in the dynamic audience.

As described above, the advertisement customizer 118 can generate a customized advertisement for each user in the dynamic audience. Alternatively, the advertisement customizer 118 can generate a customized advertisement for a group of users within the dynamic audience (e.g., one advertisement for all the users who prefer the same color). For example, the audience manager 116 can group users in a dynamic audience according to common preferences and the advertisement customizer 118 can generate a customized advertisement for each group.

In some embodiments, the advertisement customizer 118 can generate multiple advertisements for the same product to a user. In particular, the advertisement customizer 118 can customize multiple advertisements for a product showing different variations of the product, or the product in different environments, etc., and present the advertisements to the user. For example, the advertisement customizer 118 can generate advertisements showing a blue, a green, or a red smartphone. The advertisement customizer 118 can generate similar advertisements for other products served to the user (e.g., when the user belongs to other dynamic audiences). Over time, by serving advertisements that focus on different variations or aspects and characteristics of products, the advertisement customizer 118 can be used to identify preferences of the user. Those preferences can be added to the user's user profile data 122, as described above, and used in future advertisement customizations.

Similarly, the advertisement customizer 118 can generate multiple advertisements for different versions of a product. For example, the advertisement customizer 118 can generate an advertisement for a different version of the product than was previously marketed to the user. However, based on analyzing the user profile data 122, the advertisement customizer 118 may determine that the user prefers the alternative version of the product. For example, the advertisement customizer 118 can generate an advertisement showing a cheaper version of the product for a user (e.g., the same product with downgraded features) when data in the user profile data 112 indicates that the user prefers lower price points. As another example, the advertiser may request that all users in a dynamic audience above a certain income level be shown an upgraded, or more expensive version of the product. Further, if the user is not interested in an advertisement showing the upgraded version, the advertisement customizer 118 can generate an advertisement showing the standard version of the product. For example, the advertisement customizer 118 can serve the advertisement showing the standard version of the product. Thus, depending on the user profile data 122 of a user, the advertisement customizer 118 may generate an advertisement showing a basic model, standard model, deluxe model, etc., of the product. Further, the advertisement customizer 118 may show advertisements of different versions of the product to a user during the same remarketing campaign.

As described above, the storage manager 120 can store user profile data 122, advertisement data 130, product data 132, node data 134, and edge data 136. User profile data 122, advertisement data 130, and product data 132 are described above. For example, user profile data 120 can include user information 124, social networking activity data 126, and third-party content activity data 126. User profile data 120, along with advertisement data 130 and product data 132 may be used in generating customized advertisements for users in a dynamic audience, as described above.

Further, with so much data related to so many users and products, the storage manager 120 may combine, organize, or correlate data intelligently so that the data may be used in a customized manner to benefit the users of the product remarketing system 101. As a result, the storage manager 120 can quickly identify a subset of the data that is relevant to a particular user and/or product. The storage manager 120 may store records of users, products, and relationships between users and/or products in a social graph comprising a plurality of nodes and a plurality of edges connecting the nodes. The storage manager 120 can store nodes as node data 134 and edges as edge data 136.

The nodes may comprise a plurality of user nodes. A user node of the social graph may correspond to and include data associated with a user of a social networking system. A user may be an individual (human user), an entity (e.g., an enterprise, business, or third-party application), or a group (e.g., of individuals or entities). A user node corresponding to a user may comprise information provided by the user (e.g., user information 124) and information gathered by various systems, including the social-networking system (e.g., social networking activity data 126). As described above, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a “profile page”). For example, the social-networking system can access a user node corresponding to the user and construct a profile page including the user's name, a profile picture, and other information associated with the user. A profile page may include all or a portion of the information stored within a user's node based on one or more privacy settings or other configurable settings.

The nodes may also include a plurality of product nodes. Each product node may correspond to a particular product or a group of products. A product node can include any suitable information associated with a product, and in some embodiments can be included in the product data 132. For example, a product node can include a name of a product, a description of the product, an identification of one or more advertisers that provide the product, specifications for the product, price information for the product, images of the product, videos of the product, an identification of users that own or use the product, an identification of users that want the product, an identification of users that “like” the product, an identification of users that have otherwise expressed interest in or interacted with the product, a URL address for a web site associated with the product, a product category associated with the product, an identification of one or more related products, one or more recommendations or reviews of the product, one or more ratings of the product, options (e.g., size options, color options, shipping options, purchase options) for the product, a manufacturer of the product, or any other information associated with the product. Similar to user nodes, each product node of the social graph may correspond to a web page or profile page where users can access the corresponding product information. For example, the product remarketing system can access a product node corresponding to a product, and construct a profile page (e.g., viewable by a browser or mobile application) including product information from the product node.

In some embodiments, a user may reference a particular user node or product node within a social networking communication. For example, as described above, a user can include a “tag” to a node within a social networking post or comment. The tag may serve as or include a link to a profile page for the node. To illustrate, a tag for a product node representing a particular product may serve as a link to a profile page for the product. Accordingly, once a user has inserted a tag in a post or other communication, the user or other users can use (e.g., select) the tag to access the profile page for the tag. In some embodiments, the tag can include text, such as the name of the tagged product. Additionally or alternatively, the text of the tag can be visually distinguishable from other text in the communication. For example, the text of the tag can be bolded, underlined, italicized, in all caps, a different color than the other text, a different size than the other text, a different font type than the other text, and/or visually distinguishable in some other manner. Furthermore, the tag can include any other content (e.g., an image or an icon) associated with the tagged node.

In some embodiments, the storage manager 120 can assist a user to include a tag in a communication. For example, the storage manager 120 may detect that a user is typing a string of characters into a communication, search nodes for one or more nodes matching the string of characters (e.g., nodes with associated names matching the string of characters), and present one or more matching nodes to the user. In particular, the storage manager 120 can present a list of matching nodes (e.g., within a drop-down list or window) below or nearby the typed string of characters. Furthermore, the storage manager 120 can update the search for nodes and the list of matching nodes as the user continues to type. At any point, the user can select one of the listed nodes to include a tag for the node in the communication. To illustrate, as a user begins typing the name of a product in a communication, the storage manager 120 can search for products (e.g., products represented by product nodes in the social graph) having a name that matches the name or portion of name typed by the user. The user can then select the intended product from the list of matching products. The storage manager 120 can insert a tag representing the product into the communication in response to the detected selection. Thereafter, users may select or otherwise interact with the tag to access a profile page for the tagged product. Additionally or alternatively, the storage manager 120 can associate the communication and/or any related activities (e.g., likes, comments, replies) to the product node representing the product. In particular, the storage manager 120 can associate user nodes with the product node (e.g., by way of one or more edges connecting the user nodes and the product node) based on the activities of the users with respect to the communication including the tag.

An edge (stored in the storage manager 120 as edge data 136) between a pair of nodes may represent a relationship between the pair of nodes. For example, an edge between two user nodes can represent a friendship between two users. As another example, an edge between a user node and a product node can represent a relationship between a user and a product (e.g., that the user likes the product or uses/owns the product) or an interaction between the user and the product (e.g., that the user mentioned the product, shopped for the product, viewed a profile page for the product, etc.). As a further example, an edge between two product nodes can represent a relationship between two products (e.g., that the products are in a common product category, that the products are often purchased together, that users interested in one product are often interested in the other, that the products share one or more common attributes, etc.). Furthermore, an edge between a product node and a product group node (e.g., a product node 116 for a group or category of products as opposed to a single product) may represent that the product belongs to the product group.

Edges between user nodes and product nodes may be based on social networking activity data 126 obtained by the product remarketing system 101. In particular, if social networking activity data 132 indicates an interaction between a user and a product, the storage manager 120 may create an edge between a user node associated with the user and a product node associated with the product to represent that social networking activity of the user. In particular, the storage manager 120 may generate an edge (e.g., stored as edge data 136) between a user node and a product node to represent any social networking activity related to a particular product or product category, examples of which are discussed herein in more detail.

The degree of separation between any two nodes is defined as the minimum number of “hops” required to traverse the social graph from one node to the other. A degree of separation between two nodes can be considered a measure of relatedness between the users or the products represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” Degrees of separation apply equally to relationships between user nodes and product nodes. For example, a user node being connected to a product node by a single degree of separation may indicate a closer relationship or greater product interest than a connection by multiple degrees of separation. The more degrees of separation between a user node and a product node may indicate a lower likelihood of interest by the user in the corresponding product. Furthermore, a connection between a user node and a product node by way of another user node may indicate a likely interest in the product because the user is connected to another user that is connected to the product in some way. To illustrate, a user interested in purchasing a new smartphone may be interested to learn what smartphones are used by the user's friends or friends of friends. Accordingly, connections between a user node and a product node by way of one or more other user nodes may be particularly helpful to a user researching product information.

FIG. 2 illustrates an example schematic diagram of an advertisement system 200 (or simply “system 200”). As illustrated in FIG. 2, the system 200 may include a client device 202, a social networking system 204, third-party servers 206, and an advertiser 208, all of which are communicatively coupled through a network 210. As further illustrated in FIG. 2, a user 211 may interact with the client device 202 to access content and/or services on the social networking system 204 and/or the third-party servers 206. Further, in some embodiments the advertiser 208 may be associated with one or more of the third-party servers 206.

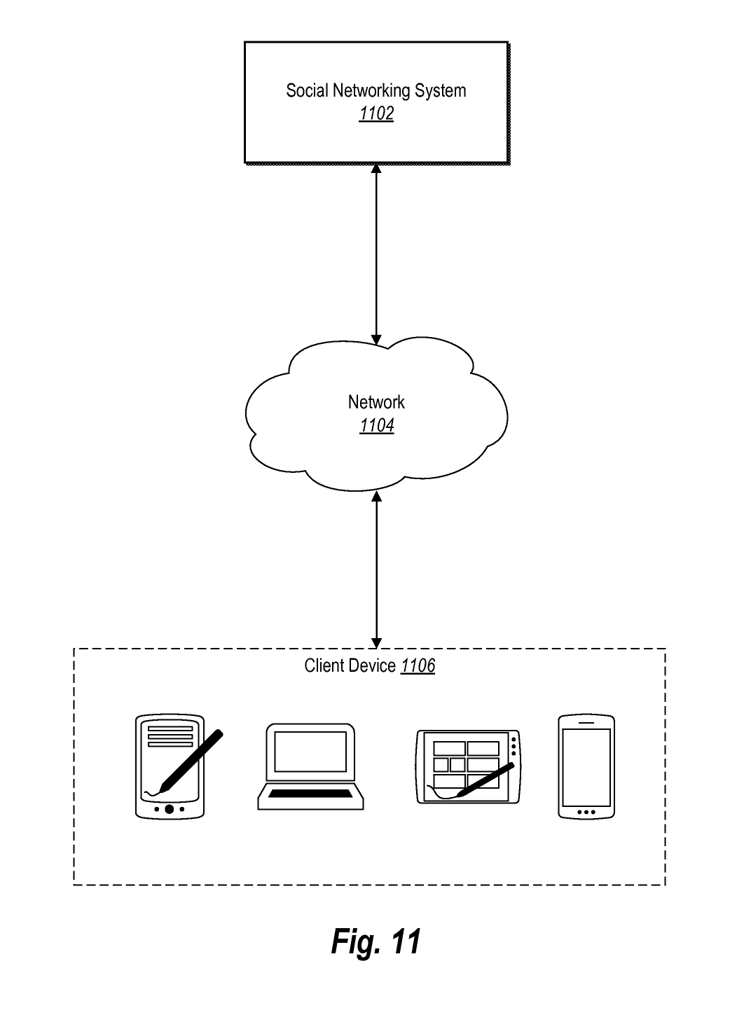

The client device 202, social networking system 204, third-party servers 206, and advertiser 208 may communicate via network 210, which may include one or more networks and may use one or more communications platforms or technologies suitable for transmitting data and/or communication signals. Although FIG. 2 illustrates a particular arrangement of the client device 202, the social networking system 204, the third-party servers 206, the advertiser 208, and the network 210, various additional arrangements are possible. For example, the client device 202 may directly communicate with the social networking system 204, bypassing network 210. Additional details relating to the network 210 are explained below with reference to FIG. 11.

As illustrated in FIG. 2, the system 200 can include a user 211. As described above, the user 211 may be an individual (i.e., human user), a business, a group, or other entity. Although FIG. 2 illustrates only one user 211, it is understood that system 200 can include a plurality of users, with each of the plurality of users interacting with the system 200 through a corresponding plurality of client devices 102.

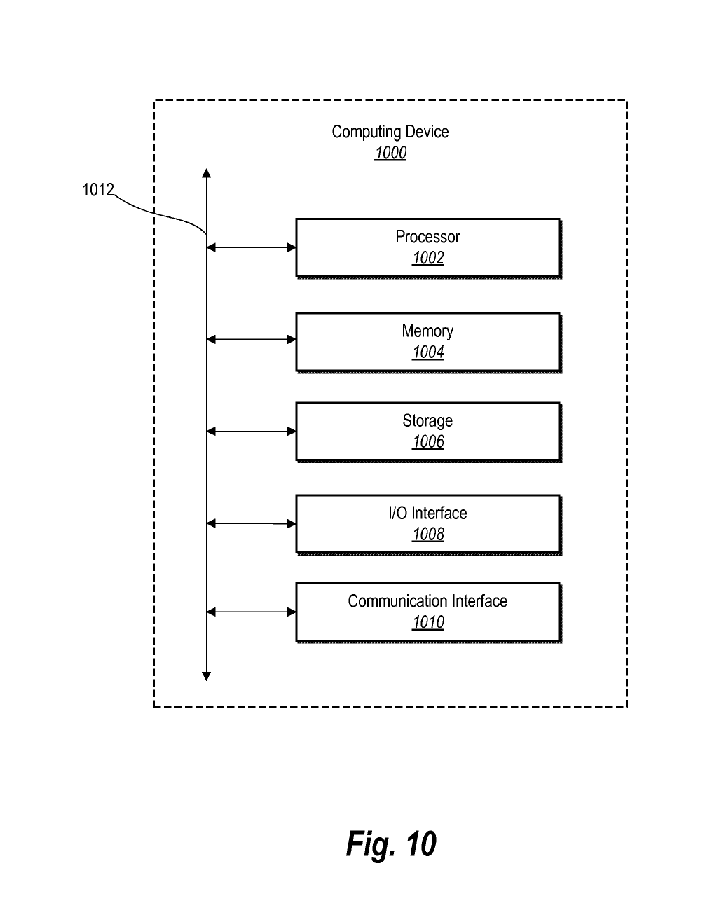

The client device 202 may include various types of computing devices. For example, the client device 202 can include a mobile device such as a mobile telephone, a smartphone, a PDA, a tablet, a laptop or a non-mobile device such as a desktop, server or other computing device. Further, client devices 202 may run dedicated mobile social networking applications associated with the system 200 and/or utilize one or more browser applications to access social networking content (e.g., webpages) associated with the system 200. In turn, the system 200 may present information and content to the users 211 by way of one or more social networking pages (e.g., web pages or pages/views of a mobile application). Additional details with respect to the client device 202 are discussed below with respect to FIG. 10.

In addition, and as shown in FIG. 2, the system 200 can include the social networking system 204. One or more computing devices executing instructions to perform the processes and provide the features disclosed herein may implement the social networking system 204. For example, one or more server devices may implement the social networking system 204. The third-party web servers 206 may similarly include one or more computing devices executing instructions to perform the processes specific to the third-party web servers 206.

The social networking system 204 may include a product remarketing system 201. For example, the product remarketing system 201 illustrated in FIG. 2 can be one example embodiment of the product remarketing system 101 illustrated in FIG. 1. For instance, the product remarketing system 201 may assist the system 200 in executing remarketing campaigns for the advertiser 208 on the social networking system 204.

In one or more embodiments, the social networking system 204 and/or the product remarketing system 201 may generate, store, receive, and transmit social-networking data, as described above, such as social network posts or messages sent from the client device 202 associated with the user 211 For example, the user 211, using the client device 202, can interact with content on the social networking system 204, such as liking, providing comments for, sharing, or viewing various social networking posts, pages, messages, and other social networking content. The social networking system 204 and/or the product remarketing system 201 may track the participation within the social networking system 204, and store social networking activity data within a social networking profile associated with the user 211 (e.g., as user profile data 122).

In one or more embodiments, an advertiser (e.g., advertiser 208) may establish a presence on the social networking system 204 in an effort to share social networking content regarding the advertiser's products with social networking system 204 users. For example, the advertiser may post information about itself, about its products or provide other information to the social networking system 204 users with a brand page associated with the advertiser. The social networking system 204 and/or the product remarketing system 201 can track the activity with respect to the merchant's social networking content, and augment the social networking profile with social networking activity data 126 that corresponds to the user's 211 activity on the social networking system 204. Additional details relating to the social networking system 204 are discussed below with reference to FIG. 11.

As further illustrated in FIG. 2, the client device 202 may also communicate with the third-party servers 206. In one or more embodiments, the third-party servers 206 can include one or more web servers or application servers that deliver third-party content to the client device 202. For example, the third-party servers 206 can provide third-party content in the form of an advertiser's and/or merchant's web site through which the user can purchase the merchant's products. Additionally, the third-party servers can provide third-party content to a merchant's standalone application installed on the client device 202, such as a mobile application on a smartphone or tablet.

In general, and as will be described below, the system 200 allows the user 211 to interact with the client device 202 to request and receive third-party content from the third-party servers 206. In one or more embodiments, the third-party content can include one or more tracking elements that cause the client device 202 to send identification information associated with the user 211, as well as identification information associated with one or more aspects of the third-party content, to the social networking system 204. The social networking system 204 can then use the identification information associated with the user 211 and the identification information associated with one or more aspects of the third-party content to update the user's 211 social networking profile (e.g., third-party content activity data 128). The social networking system 204, the product remarketing system 201, and/or the advertiser can leverage the user's 211 user profile to provide various remarketing advertisements to the user 211, as described above.

As illustrated in FIG. 2, the third-party servers 206 in FIG. 2 can represent any number of third-party servers 206 that provide access to any number of types of third-party content. For example, FIG. 2 illustrates a few examples of third-party servers 206, which include, but are not limited to, a merchant web site 206a (e.g., the advertiser 208 and/or another merchant), application server 206b (e.g., smartphone application provider), auction web site 206c, and news web site 206d (collectively, “third-party servers 206”). As described above, the merchant web site 206a may be associated with the advertiser 208 or may be a merchant independent of the advertiser 208.

Each of the third-party servers 206 may provide various types of third-party content to the client device 202 associated with the user 211. In one or more embodiments, for example, the merchant web site 206a can provide an e-commerce web site that allows the user to access information regarding the merchant's products, as well as purchase the merchant's products. In one or more embodiments, the system 200 can augment the user's social networking profile with data representing the user's 211 activity with respect to the merchant web site 206a. For example, the system 200 can identify one or more products the user 211 views while accessing the merchant web site 206a. In addition, the system 200 may identify that the user 211 selects one or more products to include in a “shopping cart” on the merchant web site 206a. Moreover, the system 200 can identify one or more products the user 211 purchases from the merchant web site 206a. Upon identifying any user activity with respect to the merchant web site 206a, the system 200 can update the user's 211 social networking profile to reflect the user's 211 activity with respect to the merchant web site 206a. For example, the product remarketing system 201 can update the third-party content activity data 126 within the user profile data 122 associated with the user 211, as described above.

In addition to the merchant web site 206a, FIG. 2 illustrates that the application server 206b can provide third-party content to the client device 202 of the user 211. For example, the application server 206b may host/support one or more applications assessable to the user 211 using the client device 202. In one or more embodiments, the application server 206b can provide third-party content to the client device 202 in the form of applications, application content, in-app purchases, text, streaming audio or video, or any other content associated with a particular application. For example, a merchant application many be installed on the client device 202 that allows a user to view and purchase one or more merchant products. Other examples of applications can include media applications, such as streaming audio or video applications. Regardless of the type of third-party content the application server 206b provides, the system 200 can identify the third-party content (e.g., songs, movies, TV shows, games, purchases) with which the user interacts and update the user's 211 social networking profile to reflect the user's 211 activity with respect to one or more applications on the client device 202, as described above.

As further illustrated in FIG. 2, an example of a third-party server 206 includes an auction web site 206c. For example, the auction web site 206c can send auction information regarding various products to the client device 202 to allow the user to participate in an online auction. Similar to the above examples, system 200 can identify third-party content that the auction web site 206c provides to the client device 202. For example, system 200 can identify a product the user views, bids on, and/or purchases though the auction web site 206c. In addition, the system 200 can identify bid amounts, bid dates, and auction ending times. The system 200 can update the user's 211 social networking profile to reflect the user's 211 activity with related to the auction web site 206c.

In addition to third-party servers 206 that can market and/or sell a merchant's products, one or more embodiments of the system 200 can identify third-party content related to topics, and update the user's 211 social networking profile with the user's activity with respect to a topic. For example, and as illustrated in FIG. 2, a third-party server 206 can include a news web site 206d that provides third-party content in the form of news and articles (e.g., sports, business, politics, entertainment). For instance, the user 211 may use the client device 202 to access the news web site 206d to check the score of the user's 211 favorite sports team. In one or more embodiments, the system 200 can identify the user's favorite sports team based on the third-party content the user accesses through the news web site 206d. In turn, the system 200 can update the user's 211 social networking profile, as described above, to reflect the user's 211 demonstrated interest in the sports team.

As illustrated above, the types of third-party content the third-party servers 206 can vary greatly and provide a broad spectrum of information about the user's 211 interests based on the user's 211 activity corresponding to the third-party servers 206. In addition, and as briefly described above, the system 200 can use user information 124, third-party content activity data 126, along with social networking activity data 124 collected from the user's 211 activity within the social network system 204, to effectively remarket products to the user 211. In particular, the system 200 can use the user profile of the user 211 to identify remarketing advertisement opportunities (e.g., including the user in a dynamic audience associated with a product).

The following demonstrates an overview of an example embodiment of the system 200, illustrated in FIG. 2. For instance, the system 200 may identify that the user 211 is interested in a hat and jersey for the San Francisco Giants because the user accesses third-party content, such as hats and jerseys associated with the San Francisco Giants, from one or more on merchant web sites 206a. The system 200 can update the user profile data 122 associated with the user 211 with third-party content activity data 126 that indicates the user's 211 interests in the hat and/or jersey.

Using the user profile (e.g., stored as user profile data 122), the system 200 can identify one or more remarketing opportunities. For example, based on a remarketing advertisement agreement with the merchant the system 200 can cause the social networking system 204 to provide a remarketed advertisement (e.g., in a post, a newsfeed message, a direct message) to the client device 202 to present to the user 211 displaying the hat or jersey in an advertisement. Additional details and features of system 200 will be discussed in detail below.

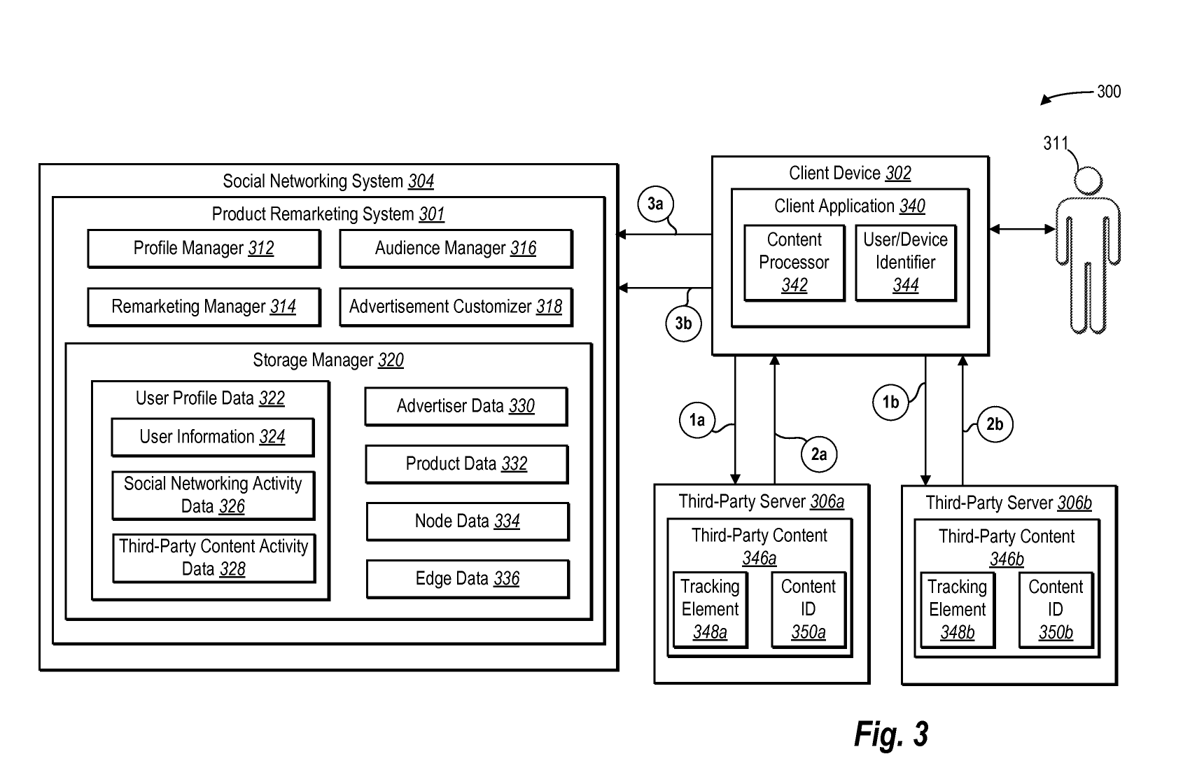

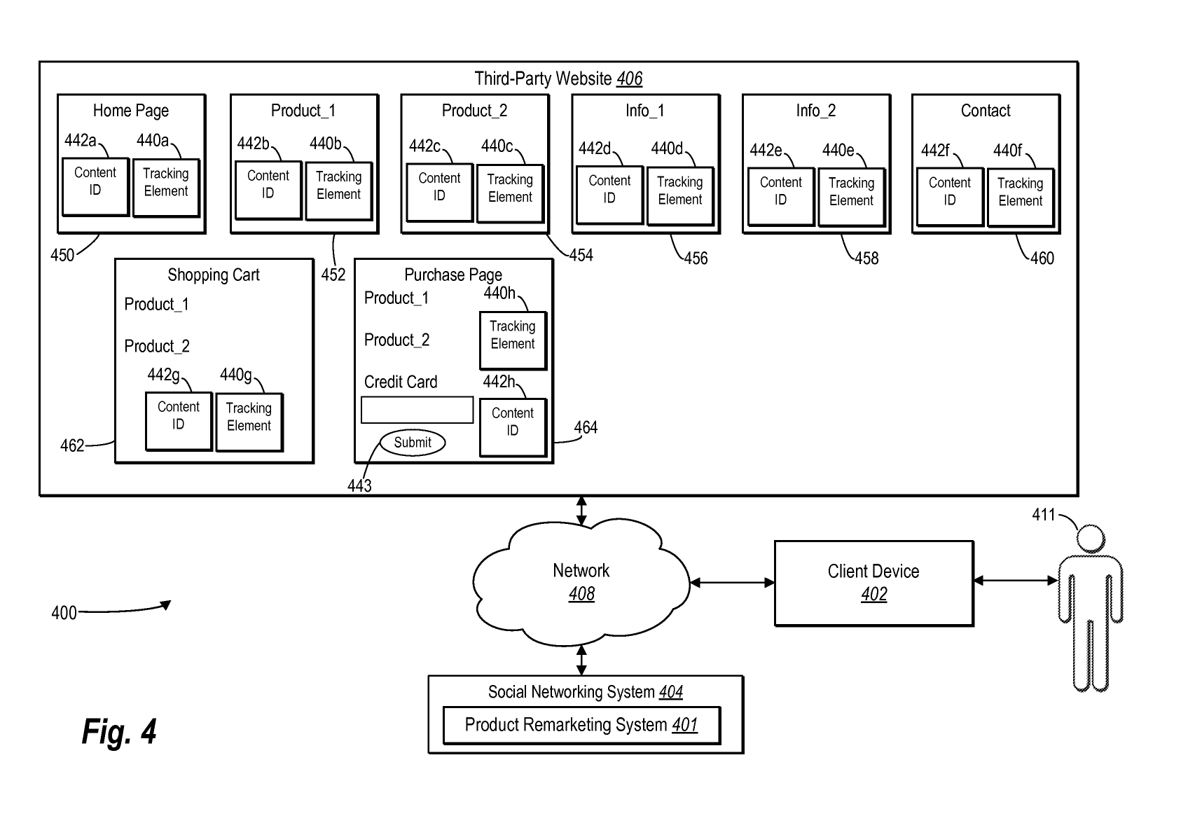

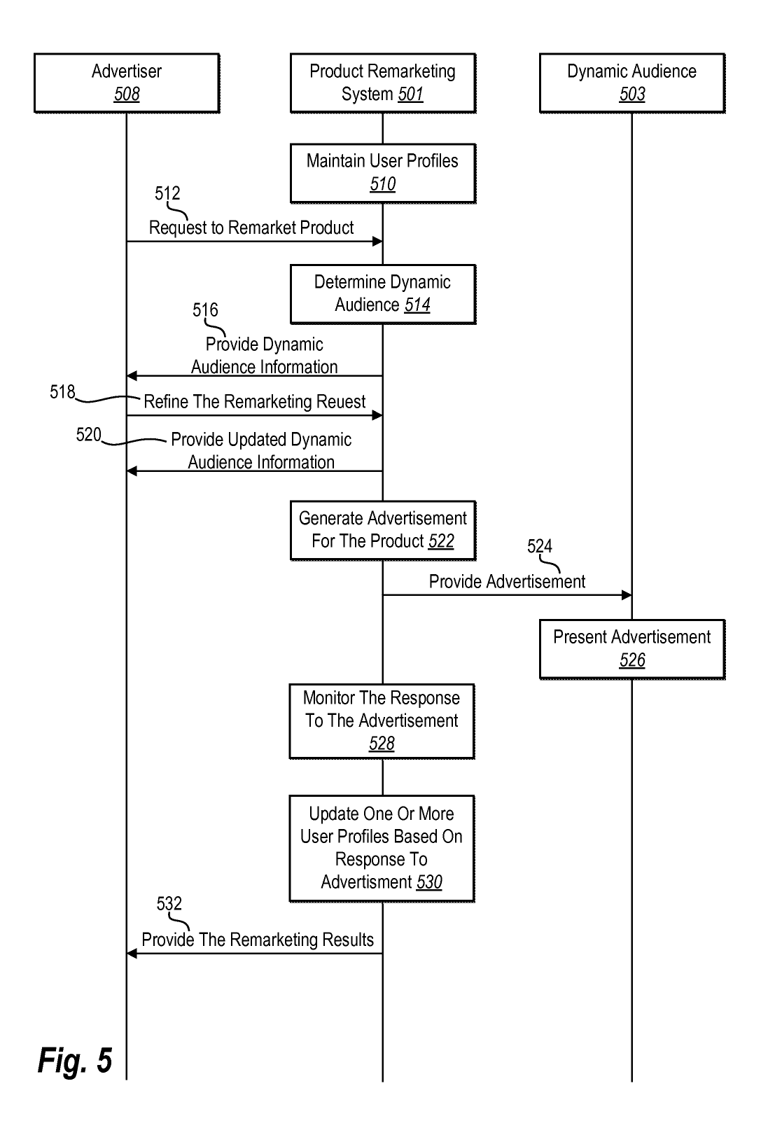

The below discussion with respect to FIGS. 3-4 provides details related to example systems and methods that an advertisement system can use to track user activity with respect to third-party content, including identifying specific content and associating the specific content with a user profile corresponding to a specific user. Meanwhile, FIG. 5 provides details relating to example systems and methods that an advertisement system can use to provide remarketing advertisements as part of a remarketing campaign to one or more users based on user profiles. Although FIGS. 3-4 illustrate various different components of an advertisement system, it is understood that the components discussed with respect to FIGS. 3-4 can be combined into a single advertisement system. In particular, FIGS. 3-4 illustrate that various components of an advertising system can be included within a social networking system. In one or more embodiments, the social networking system components discussed with respect to FIGS. 3-4 are combined into a single social networking system.

As mentioned, FIG. 3 illustrates a schematic diagram of an advertisement system 300 (or simply, “system 300”) in accordance with one or more embodiments. In particular, the system 300 can represent one or more embodiments of the system 300 discussed above with reference to FIGS. 1 and 2. For example, the client device 302, social networking system 304, and third-party servers 306a-b, shown in FIG. 3, can include some or all of the features discussed above with respect to client device 202, social networking system 204, and third-party servers 206a-d, respectively.

In general, and as FIG. 3 illustrates, a user 311 can interface with the client device 302 and cause the client device 302 to send and receive electronic information to and from the social networking system 304 and the third-party servers 306a-b. For example, the user 311 can use the client device 302 to communicate with a social networking system 304 that provides a product remarketing system 301, as shown in FIG. 3. The product remarketing system 301 in FIG. 3 may be an example embodiment of the product remarketing system 101 described above in connection with FIG. 1. For example, the product remarketing system 301 can include a profile manager 312, a remarketing manager 314, an audience manager 316, an advertisement customizer 318, and a storage manager 320 that correspond to the profile manager 112, a remarketing manager 114, an audience manager 116, an advertisement customizer 118, and a storage manager 120 described above in connection with FIG. 1.

As described above, the user 311 can use the client device 302 to communicate with the social networking system 304, such as to post messages/updates, view social networking content (e.g., posts, pictures, messages), interact with content (e.g., “like” or “comment” with respect to the social networking content), search content, etc., as described above. Further, the user 311 can interact with the client device 302 to communicate with one or more third-party servers 306a-b, as shown in FIG. 3. For example, as illustrated in FIG. 3, the user 311 can use the client device 302 to request third-party content 346a and 346b from third-party servers 306a and 306b, respectively. The third-party servers 306a-b, in response to a request for content, can provide third-party content 346a-b to the client device 302 for presentation to the user 311 on the client device 302.

In particular, and as illustrated in FIG. 3, the client device 302 can include a client application 340 that allows the client device 302 to request and receive third-party content 346. For example, in one or more embodiments, the client application 340 may be a web browser application. Alternatively, the client application 340 may be a standalone application having a particular purpose, such as a merchant shopping application, a music application, a streaming video application, a game application, or any other type of application, program or combination of hardware and software that at least in part facilitates receiving third-party content 346a-b from the third-party servers 306a-b.

Notwithstanding a particular client application 340, in one or more embodiments, the client application 340 may include a content processor 342. For example, the content processor 342 can be a combination of software, hardware, and/or firmware associated with, or accessed by, the client application 340 that processes the third-party content 346a-b that the client application 340 receives from the third-partyer servers 306a-b. In particular, content processor 342 can process code associated with third-party content 346a-b in order to present the third-party content 346a-b to the user 311.

In one or more embodiments, for example, the content processor 342 can include a rendering engine within a web browser application. The rendering engine can render third-party content 346a that the client device receives from third-party server 306a. For example, in the event that the third-party content 346a includes a HTML document, the rendering engine can read the HTML document and render the HTML elements into visible web pages. In one or more additional embodiments, the content processor 342 can render, present, play, and/or process various types of third-party content 346, such as digital image content, video content, audio content, and any other type of digital content.

As further illustrated in FIG. 3, the client application 340 can include a user/device identifier 344 (or simply “identifier 344”). Generally, the identifier 344 includes data that identifies the user 311. For example, in one or more embodiments, the identifier 344 can include the user's 311 social networking system user ID that can be used within the social networking system to identify the user 311. Alternatively, the identifier 344 can include a client device ID that is associated with the user 311 within the social networking system 304. For example, given the user's 311 client device ID, the social networking system 304 can lookup the user's 311 social networking system user ID within the social networking system 304. In one or more embodiments, the identifier 344 may include more than one identifier 344 associated with user 311.

Notwithstanding the type of identifier 344, the location of the identifier 344 on the client device 302 can vary from one embodiment to the next. For example, and as illustrated in FIG. 3, the identifier 344 can be located within the client application 340. In particular, the client application may control, update, and otherwise provide the identifier 344. Alternatively, the identifier 344 may be located on the client device 302, but not necessarily be directly associated with or included within client application 340. For example, client device 302 may maintain the identifier 344 such that several client applications have access to the identifier 344.

In the event that the client application 340 is a web browser, the identifier 344 can be a cookie (e.g., web cookie, browser cookie, etc.). In general, a cookie is a small piece of data sent from a source to the client device and stored in association with the web browser. In one or more embodiments, the cookie includes data that identifies s user 311, such as the user's 311 social networking user ID and/or a client device ID associated with the user 311. Thus, a cookie can be used as the identifier 344 to provide the ability for the client application to access information regarding the user's 311 identity.

In one or more embodiments, the identifier 344 is a cookie that is associated with a domain that is different from a domain of a web site that the web browser is currently presenting. For example, in one or more embodiments, the identifier 344 is a cookie that is associated with a domain corresponding to the social networking system 304 and/or the product remarketing system 301, or in other words, the social networking system 304 and/or the product remarketing system 301 placed the cookie within the client application 340 (e.g., when the user 311 accessed the social networking system 304). For instance, the user 311 may have used the client application 340 (e.g., web browser) to request the user's 311 social networking page from the social networking system 304. Along with providing the client application 340 with the user's 311 social networking page, the social networking system 304 and/or the product remarketing system 301 also provides a cookie associated with the social networking system 304 that includes the user's 311 identification information.

Although, in the above example embodiment, the identifier 344 can be a cookie that corresponds to the social networking system 304 and/or the product remarketing system 301 (e.g., the cookie provides data to the social networking system 304 and/or the product remarketing system 301), the cookie can be activated upon the client application 340 receiving third-party content 346a. For example, the content processor 342 can process third-party content 346a from the third-party server 306a (e.g., render a web site in a web browser), and in response, the identifier 344 within the cookie, or a copy of the entire cookie itself, is sent to the social networking system 304 and/or the product remarketing system 301. Thus, as described above, the client device 302 can send user 311 identification information upon the user 311 accessing third-part content 346 to the social networking system 304 and/or the product remarketing system 301.

A cookie is only one example of the identifier 344. Alternatively, the identifier 344 can include, but is not limited to, a session variable, an IP Address associated with the client device 302, a unique device identification number (e.g., MAC address) of the client device, URL query strings, and any other known method of storing and/or providing identification information associated with the user 311 via the client device 302.

Additionally, in one or more embodiments, the client application 340 and/or the client device 302 may include multiple identifiers 344 that are each associated with the social networking system 304 and/or the product remarketing system 301. In particular, the social networking system 304 and/or the product remarketing system 301 can send multiple identifiers 344 to the client device 302 and/or client application 340. In one or more embodiments, the multiple identifiers 344 can each be designed to interact with various different applications and various types of third-party content 346 so that the user's 311 activity on the various different applications and third-party content 346 can be tracked and associated to the user 311 for a remarketing campaign within the social networking system 304. For example, a first identifier 344 can be associated with a web browser application, while a second identifier 344 is associated with a mobile application.

Furthermore, one or more embodiments of the advertisement system 300 may not require an identifier. For example, in one or more embodiments, the user 311 may have established an active social networking system session through the client device 302 (e.g., the user 311 is signed into the social networking system 304 through a web browser or social networking system application). At the same time, the user 311 can cause the second client application 340 to request, receive, and process third-party content 346.

In such a case, the social networking system 304 and/or the product remarketing system 301 can use the active social networking system session to detect the user's 311 third-party content activity on the client device 302. For example, the social networking system 304 can use a web application that is able to detect the user's 311 third-party content activity, such as looking at a product. Since the social networking system 304 already registers the identity of the user 311, the social networking system 304 and/or the product remarketing system 301 can associate the third-party content activity with the user 311 without a user identifier 344.

Regardless of the particular embodiment of the client application 340, the user 311 can use the client device 302 to request and receive third-party content 346a-b from one or more third-party servers 306a-b, as illustrated in FIG. 3. Various aspects of the third-party servers 306a-b will be discussed with reference to third-party server 306a, although the various aspects may apply to both third-party servers 306a-b.

In particular, third-party server 306a can include third-party content 346a that is available to send to the client device 302. Third-party content 346 can include any digital content that a third-party server 306a can provide to the client device 302. As discussed in detail above, third-party content can include a web page, digital documents, digital media (images, audio, video), or any other digital content or combinations thereof.

In addition, and as shown in FIG. 3, the third-party content 346a can include a tracking element 348a and a content ID 350a. In general, the tracking element 348a and the content ID 350a are used by the advertisement system 300 to identify the third-party content 346a (e.g., categories, products, sales, images, comments, reviews, etc.) with which the user 311 interacts using the client device 302. For example, the tracking element 348a may include one or more tracking pixels (e.g., JavaScript or another piece of software code) that can cause the client device 302 to send the social networking system 304 information related to the third-party content 346a and the user 311 (e.g., the identifier 344 and the content ID 350a). Alternatively, or additionally, the tracking element 348a may be in the form of a software development kit (SDK) or other code executable on mobile device platforms.

Regardless of a particular embodiment of the tracking element 348a, the tracking element 348a can be included within the third-party content 346a such than when the third-party server 306a sends the third-party content 346a to the client device 302, the tracking element 348a is also sent to the client device. For example, the tracking element 348a can be included in the markup language of a web site. Thus, when the content processor 342 processes the third-party content 346a (e.g., renders the content), the content processor 342 also reads and executes the tracking element 348a, causing the client device 302 to send an electronic communication to the social networking system 304 that includes identification about the user 311 and the third-party content 346a for purposes of the social networking system 304 tracking the user's 311 third-party content activity.

As FIG. 3 further illustrates, and as briefly described above, the third-party content 346a can also include, or be associated with, a content ID 350a. The content ID 350a can be a unique identifier that corresponds to the third-party content 346a. For example, the content ID 350a can comprise an alphanumeric code that associates with a particular product(s), merchant, topic, or combination of the above. The third-party content 346a can include the content ID 350a such that the third-party server 306a sends the content ID 350a to the client device 302 along with the third-party content 346a. For example, in one or more embodiments, the content ID 350a can be embedded within the tracking element 348a.

In one or more embodiments, the third-party provider (e.g., a merchant and/or advertiser) assigns the content IDs 350a. For example, a merchant can assign each of its products a unique content ID. The merchant can then associate the unique content ID with each piece of third-party content (e.g., web page) that corresponds to a particular product. The merchant can provide a list of content IDs and corresponding products to the social networking system 304. Therefore, given the content ID associated with third-party content 346a, the social networking system 304 can identify a particular product, as will be discussed in detail below.

In addition to identifying a particular product, topic, and/or merchant, the content ID 350a can also identify features of the third-party content 346a that may indicate a user's level of interest in the third-party content 346a. For example, the content ID 350a can be associated with a “shopping cart” web page that indicates the user has placed one or more products into an online shopping cart. Similarly, the content ID 350a can be associated with a “purchase confirmation” web page that indicates the user has purchased one or more products via an online purchasing process.

In one or more embodiments, the third-party server 306a can dynamically generate the content ID 350a to indicate information about the third-party content 346a. For example, a first part of the content ID 350a may indicate that the web page is a “shopping cart” web page. In addition, a second part of the content ID 350a can indicate one or more products that are currently in the shopping cart. Thus, as the user adds or removes items from the shopping cart, the content ID associated with the shopping cart web page is updated to reflect the products currently in the shopping cart. Various other methods of generating and assigning the content ID 350a to the third-party content 346a can be used, such as using UPC codes, or other such previously defined identifiers, as the content ID 350a.

Regardless of the particular form of the content ID 350a, the system 300 can use the content ID 350a to allow the social networking system 304 to identify the third-party content 346a that the user 311 accesses. For example, FIG. 3 illustrates an example embodiment of the client device 302 providing the social networking system 304 with activity identification data that allows the social networking system 304 to identify and associate a user's 311 third-party content activity with a user's social networking profile.

In particular, step 1a in FIG. 3 can include the user 311 causing the client application 340 to send a request to the third-party server 306a for third-party content 346a. In response, Step 2a in FIG. 3 can include the third-party server 306a providing the client application 340 the third-party content 346a. As explained above, the third-party content 346a can include the tracking element 348a and the content ID 350a.

Upon receiving the third-party content 346a, the content processor 342 within the client application 340 can process the third-party content 346a. As part of processing the third-party content 346a, the content processor 342 can process the tracking element 348a. The tracking element 348a can cause the client application 340 and/or client device 302 to identify the identifier 344 and the content ID 350a associated with the third-party content 346a. In addition, FIG. 3 illustrates step 3a that shows that the tracking element 348a can cause the identifier 344 and the content ID 350a to be sent to the social networking system 304 and/or product remarketing system 301. Thus, the client device 302 can send the social networking system 304 and/or product remarketing system 301 third-party content activity data 326 that indicates the user's 311 activity with respect to the third-party content 346a.

As further illustrated in FIG. 3, the system 300 can follow the same or similar process for providing the social networking system 304 with the user's 311 activity with respect to third-party content 346b. For example, in response to a request from the client device (step 1b) third-party server 306b can send the client device 302 the third-party content 346b that includes the tracking element 348b and the content ID 350b (step 2b). The content processor 342 can then process the third-party content 346b, including the tracking element 348b, which causes the client device 302 to send the identifier 344 and the content ID 350b to the social networking system 304 and/or product remarketing system 301 (step 3b). Therefore, using the above principles, the system 300 can provide systems and methods of associating the user 311 with specific third-party content 346, regardless of the source of the third-party content. The system 300 can then user the user profile data 320 to remarket products to users within the social networking system 304, as described above.

As discussed above with respect to FIG. 3, the system 300 can be used with various types of third-party content. FIG. 3, for example, illustrates one or more embodiments of third-party content that can be incorporated within an advertisement system 300 (or simply “system 300”). In particular, a user 311 can use a client device 302 to interact with a third-party web site 306 and social networking system 304, and described above with reference to FIGS. 1-3. For example, the third-party web site 306 that can represent a merchant web site (e.g., see FIG. 2) that may be associated with an advertiser. Regardless of the particular content within the third-party web site 306, the principles described with reference to the third-party web site 306 are applicable to any third-party content disclosed herein.

As further illustrated in FIG. 4, the third-party web site 406 can include multiple web pages 450, 452, 454, 456, 458, 460, 462, and 464 (collectively “web pages”). Each of the web pages can include particular content or information that is distinct from the other web pages. For example, the home page 450 and contact page 460 may include general information about a particular merchant. Moreover, product 1 page 452 and product 2 page 454 may include general information directed at particular products. Likewise, info 1 page 456 and info 2 page 458 can include detailed information related to products 1 and 2, respectively. In addition, third-party web site 406 can include a shopping cart page 462 indicating products the user 411 has placed into a virtual shopping cart, and a purchase page 464 indicating products the user 411 purchases through the third-party web site 406.

As further illustrated in FIG. 4, each web page can include a tracking element 440a-h as discussed above with respect to FIG. 4. In addition, each web page can include a content ID 442a-h, where each content ID 442a-h is a unique identifier associated with the contents of the corresponding web page. Thus, when the client device 402 receives a particular web page from the third-party web site, the client device 402 processes the tracking element associated with the particular web page, and sends activity identification information, including the content ID associated with the particular web page, to a social networking system 404 and/or a product remarketing system 301, and the user's 411 user profile (e.g., user profile data 320) is updated with third-party content activity data 322, as discussed above in detail.

Due to each web page being associated with a unique content ID, it is possible to track the level of interest a user may have in a particular product. For example, if the third-party activity data only indicates that the user interacted with the homepage 450, the system 400 may indicate a general interest in the merchant's products. Additionally, however, if the third-party activity data indicates that the user interacts with the product 1 page 452, the system 400 can infer that the user 411 shows more than a general interest with respect to product 1. Moreover, if the user 411 further interacts with info 1 page 456, the system 400 can further infer that the user 411 shows an additional level of interest in product 1 because the user 411 took the time to further research details relating to product 1. The same would be true with respect to the user's 411 interaction with product 2 page 454 and info 2 page 458.

In addition, the system 400 can infer an even greater level of interest with respect to products 1 and 2 if the user 411 decides to place the products into a shopping cart, as illustrated in the shopping cart page 462. For example, upon placing products 1 and 2 into the shopping cart, the third-party web site 406 can provide a shopping cart page 462 that has a content ID that indicates a shopping cart page 462, as well as indicates the products that are included within the shopping cart. Thus, the system 400 can infer that the user 411 has a fairly high level of interest in products 1 and 2. Moreover, and as illustrated in FIG. 4, the system 400 can conclude user interest in a products 1 and 2 upon the user 411 purchasing the products 1 and 2, as indicated on the purchase page 464.

Therefore, in addition to providing tracking information across various third-party content providers, FIG. 4 illustrates that the particular third-party content with which the user 411 interacts from a third-party content provider can indicate varying levels of user 411 interest in the products, topics, merchants, and/or other information found within the third-party content. Using the observed levels of interest, the system 400 can improve product remarketing to the user 411 within the social networking system 404.

Notwithstanding the particular third-party content with which a user interacts, one or more embodiments of the advertisement system can use user profiles to identify remarketing opportunities. For example, FIG. 5 illustrates an advertisement system 500 (or simply “system 500”) that includes a product remarketing system 501, an advertiser 508, and a dynamic audience 503. The product remarketing system 501 and the advertiser 508 in FIG. 5 may be an example embodiment of the product remarketing system 201 and the advertiser 208 described above in connection with FIG. 2. The product remarketing system 501 may be included in a social networking system 304, as described above. Further, the dynamic audience 503 may include social networking users that are each associated with computing devices, as described above.

As an example summary of a remarketing advertisement process that uses one or more embodiments of the advertisement systems discussed above, FIG. 5 illustrates an example process diagram of providing a remarketing advertisement to one or more users of a social networking system. In particular, FIG. 5 illustrates example steps, processes, and methods performed by and between a product remarketing system 501, an advertiser 508, and a dynamic audience 503. As described above, the product remarketing system 501 may be included in a social networking system 304. In addition, the dynamic audience 503 may include social networking users that are each associated with computing devices, as described above. The product remarketing system 501, the advertiser 508, and the dynamic audience 503 can include one or more characteristics and features discussed above with respect to FIGS. 1-4.

As illustrated in FIG. 5, the product remarketing system 501 can maintain a plurality of user profiles, as shown in step 510. For example, each user in a social networking system 304 can be associated with a user profile, which the product remarketing system 501 may store as user profile data 320. As described above, user profile data 320 for each user may include user information 324, social networking activity data 326, and third-party content activity data 328.

Further, as described above, the product remarketing system 501 can continuously update (e.g., add, remove, augment, etc.) data within the user profile data 320 for each user 311. For example, when a client device 302 sends activity data for a user 311 (e.g., data indicating a user's interest in a product), the profile manager 312 in the product remarketing system 501 can update the user's 311 social networking profile.

In step 512, the advertiser 508 can send a remarketing request to the product remarketing system 501. The remarketing request can indicate which products the advertiser 508 desires to remarket. For instance, the advertiser 508 may desire to remarket each product offered by the advertiser 508. Alternatively, the advertiser 508 may specify to remarket a single product or group of products.

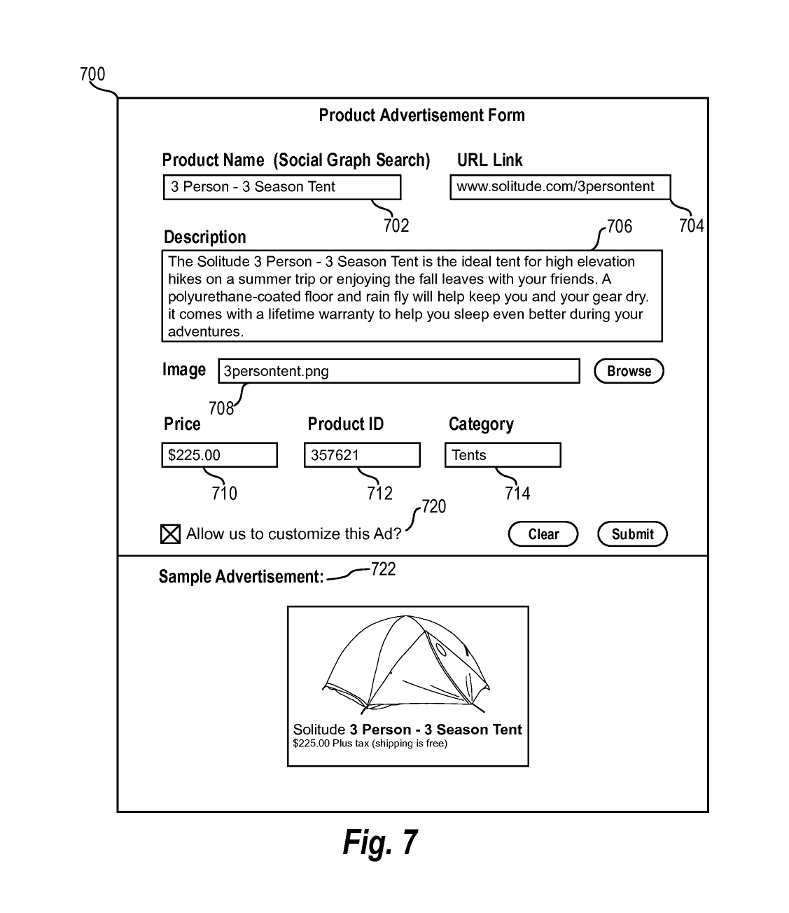

In some embodiments, the remarketing request includes parameters for the remarketing campaign, as described above. For example, remarketing campaign parameters may include a campaign budget, number of advertisements served, campaign duration, etc. Further, the advertiser 508 may include which social networking users the advertiser 508 desires to target in the remarketing request. Additional detail regarding the remarketing request is provided below in connection with FIG. 7.

Upon receiving the remarketing request, the product remarketing system 501 may determine a dynamic audience 503, illustrated as step 514. As described above, the product remarketing system 501 can identify a product from the remarketing request, analyze user profile data 320 to determine which users in the social networking system 304 are associated with the identified product, and create a dynamic audience 503 to included users associated with the identified product. The product remarketing system 501 can create a separate dynamic audience 503 for each product associated in the request, or can create a dynamic audience 503 that includes users who have a detected interest in any products identified in the remarketing request.

In some example embodiments, the product remarketing system 501 can identify dynamic audience information (e.g., common attributes and characteristics of users within a dynamic audience 503). For example, the product remarketing system 501 can identify that 78% of the dynamic audience 503 is female, 120 users viewed the product on multiple web sites, and/or over half of the users live in California. The dynamic audience information can also include the number of users in the dynamic audience 503 as well as the number of users for whom an interest is detected for a particular level of interest in the product (e.g., the number of users who viewed, selected, requested additional information, compared, commented, added to cart, removed from cart, added to a wish list, etc. for the product).

As described above, and as shown in step 516, the product remarketing system 501 can provide the dynamic audience information to the advertiser 508. For example, the product remarketing system 501 can indicate the number of users in a dynamic audience 503. Additionally or alternatively, the product remarketing system 501 can provide product information corresponding to groups of users with a dynamic audience 503 (e.g., the number of users who added the product to a shopping cart, or the number of users who prefer the product in gold), as described above.

In some embodiments, delivering dynamic audience information to the advertiser 508 can improve the overall remarketing process. For example, the product remarketing system 501 may indicate that a large number of users in a dynamic audience 503 prefer the product in red. However, if the product remarketing system 501 does not have an image of the product in red, the product remarketing system 501 can request that the advertiser 508 provide an image of the product in red.

In step 518, the advertiser 508 can optionally refine the remarketing campaign based on the dynamic audience information. As described above, the advertiser 508 may filter the number users (e.g., membership) in a dynamic audience 503. For example, if the number of users in a dynamic audience 503 exceeds 100,000, the advertiser 508 may desire to add additional audience filter criteria to reduce the number of users in the dynamic audience 503.

Upon applying the additional audience filter criteria, the product remarketing system 501 can optionally provide updated dynamic audience information to the advertiser 508, shown in step 520. The process of providing dynamic audience information, refining the dynamic audience 503, and providing updated dynamic audience information to the advertiser 508 can be repeated. In other words, steps 518 and 520 can be repeated a number of times until the advertiser 508 is satisfied with the number of users, or type of users in the dynamic audience 503. FIG. 6 below provides additional description regarding dynamic audience filtering and providing feedback (e.g., dynamic audience information) to an advertiser 508.

In step 522, the product remarketing system 501 may generate one or more advertisements for one of the products identified in the remarketing request. As described above, the product remarketing system 501 may generate customized advertisements tailored to each user 311 in the dynamic audience 503. For example, for users whose user profile indicates a preference for the a color, a brand, a design, and/or a sports team, the product remarketing system 501 can generate an advertisement showing the product in the preferred color, design and/or being associated with the preferred brand or sports team. In this manner, the product remarketing system 501 can generate one or more customized advertisements that are tailored to users 503 in the dynamic audience 503.

In some embodiments, the product remarketing system 501 can generate multiple advertisements for the same user 311 within a dynamic audience 503. For example, the product remarketing system 501 can generate one advertisement for when the user is accessing the social networking system 304 on a mobile device, and another advertisement for when the user is accessing the social networking system 304 via a laptop web browser. As another example, the product remarketing system 501 can present various advertisements for the same product to the user 311 during the remarketing campaign based other versions on the product advertisement being unsuccessful, as described above.

In one or more embodiments, the product remarketing system 501 can generate an advertisement using a template that is customized to a user 311 based on the user's social networking profile. For example, each user profile can include a personalized user template tailored to the user 311. The template can define advertisement characteristics preferred by the user, such as colors, brands, price, images, prose, formality, typeface, fonts, etc.

In addition, in some example embodiments, the template can include content fields preferred by the user and omit other content fields. The content fields can also be defined according to user preference. For example, the template can include a limited product description field because the user 311 prefers shorter product descriptions. In another instance, the template may not include a product description field because the user 311 prefers advertisements having a picture, title, price of a product, and not description. As such, the template for the user 311 includes a picture filed, a title field, a price field, and does not include a product description field.

Further, a user profile may include multiple templates. For example, one template may be customized for advertisements served to the user 311 on mobile devices. Another template may be customized for serving advertisements to the user 311 in a web browser. As another example, one template may be customized for serving advertisements relating to electronics, while another template may be used when serving advertisements relating to home clothing.

Using the template, the product remarketing system 501 may further customize an advertisement to a user 311 in a dynamic audience 503. For example, the product remarketing system 501 can, based on a user's 311 social networking profile, identify a preferred image to display in a remarketing advertisement. The product remarketing system 501 may place the user-preferred image in the image field in the template. Thus, the product remarketing system 501 can increase the likelihood that a user 311 will engage with a remarketing advertisement when using a template tailored for the user 311.

In step 524, the product remarketing system 501 can provide the customized product remarketing advertisements to the dynamic audience 503. In particular, the product remarketing system 501 can send the one or more remarketing advertisements to client devices 302 associated with users in the dynamic audience 503. Upon receiving the product remarketing advertisement, each client device 302 can present the advertisement to a corresponding user 311, shown in step 526. As described above, the client device 302 can present the advertisement in a web browser, mobile application (e.g., a native or third-party application), or using another medium.

The product remarketing system 501 can monitor each user's response to the product remarketing advertisement, as illustrated in step 528. In particular, the product remarketing system 501 can monitor when a user reads, hovers over, selects, or ignores an advertisement. Further, when an advertisement leads to a product conversion (e.g., the user purchases the product a result of the advertisement), the product remarketing system 501 can note characteristics of the advertisement to use in further advertisement for the user 311. As described above, advertisement characteristics can include colors, brands, price, images, prose, formality, typeface, fonts, etc. For example, the product remarketing system 501 can identify that advertisements served to a user 311 during morning hours result in higher conversion rates that advertisements severed in the afternoon or evenings. Similarly, the product remarketing system 501 can identify that a user 311 regularly selects remarketing advertisements associated with particular brand or sports team.

In step 530, the product remarketing system 501 may update the user profile for a user 311 based on the user's response to remarketing advertisements, as described above. For example, if the product remarketing system 501 identifies that a user 311 prefers a particular attribute or characteristic, the product remarketing system 501 can update the user profile for the user 311. Then, when generating future remarketing product advertisements for the user 311, the product remarketing system 501 can draw on the updated attributes and characteristics that the user 311 prefers to include remarketing advertisements. Similarly, the product remarketing system 501 can update the user profile of a user 311 when the product remarketing system 501 identifies attributes that the user dislikes. For example, the product remarketing system 501 may update a user's 311 social networking profile to indicate that the user does not select advertisements having long product descriptions, written in a formal tone, or associated with a particular company.

In some example embodiments, the product remarketing system 501 can provide remarketing results to the advertiser 508, as shown in step 532. In particular, the product remarketing system 501 may indicate to the advertiser 508 which remarketing campaigns are performing as expected, under performing, or over performing. As described above, the advertiser 508 can modify a remarketing campaign based on the results provided by the product remarketing system 501. For example, the advertiser 508 may modify the parameters of the remarketing campaign, such as extending the length of a remarketing campaign achieving above average number of conversions.

In some example embodiments, the product remarketing system 501 can indicate common characteristics of users in a dynamic audience 503 that are positively interacting with advertisements for a product. For example, the product remarketing system 501 may indicate that males over 50 years old selected the product advertisement 65% of the time. In response, the advertiser 508 can increase the number of advertisements for the product served to males over 50 years old and lower the number advertisements for the product served to other users who are less likely to select the advertisement. Further, the advertiser 508 can use the feedback in future remarketing campaigns and/or in the advertiser's 508 own advertising efforts.

FIG. 6 illustrates a graphical user interface (or “GUI”) including an example target audience form 600 in accordance with one or more embodiments. An advertiser 208 can use the target audience form 600 to filter users 211 in a dynamic audience. For example, as described above, an advertiser 208 may desire to modify (e.g., narrow or enlarge) the number of users 211 or type of users 211 within a dynamic audience for one more products associated with a remarketing campaign.

The target audience form 600 may include a product header, a portion for audience filter criteria 604, and a portion for audience information 604. The header portion may include a product field 602 that indicates the product being remarketed. As described above, a dynamic audience may be determined based on a user's interest in the product the advertiser desires to remarket on the social networking system 204. As such, the number of users 211 in a dynamic audience corresponds to the product being remarketed.

In some embodiments, the target audience form 600 can display multiple products. For example, the advertiser 208 can add additional products to the target audience form 600 (e.g., by selecting the add product button 620). In the case of multiple products, the target audience form 600 can allow the advertiser 208 to specify whether users 211 in the dynamic audience need to be associated with all products, any of the products, or a combination thereof to be included in the dynamic audience. For example, after the advertiser 208 adds a second product, a selectable option may appear to allow the advertiser 208 to select whether users 211 in the dynamic audience need to have an affinity to at least one product, or for both product. For instance, the selectable option may be a dropdown menu having the options “and” and “or.”

In addition, the advertiser 208 may remove a product from the target audience form 600. For example, the advertiser 208 can select the remove product button 622 to remove a product. When products are added or removed, the number of users 211 in the dynamic audience updates, as described below.

The audience filter criteria 604 may include a number of filter categories 624a-d, each including one or more selectable filter options 626a-p. The categories 624 may include demographics 624a, living 624b, work and education 624c, and likes and interests 624d. Additional categories can also include basic information, personal, family, relationships, financial, social, personal preferences (e.g., favorite color), etc. As such, the audience filter criteria 604 may be scrollable to reveal addition categories 624.

An advertiser 208 can add criteria in connection with each selectable filter option 626a-p. For example, the advertiser 208 can click on the gender selectable option 626a and add a criterion of male or female. Similarly, the advertiser 208 can input a criterion in connection with the current city selectable option 626i. In some instances, the advertiser may input multiple criteria for one selectable filter option 626. Further, an advertiser 208 can select the more option 628 (shown as a button) to input additional criteria. In this manner, the advertiser 208 can add (or remove) criteria to filter the numbers of users 211 (e.g., dynamic audience membership) in the dynamic audience.

In one or more embodiments, the target audience form 600 may have default filters preselected. The defaults selection may be, for example, customized for an advertiser 208. For example, the target audience form 600 can store criteria previously set by an advertiser 208 and populate the corresponding selectable filter options 626 when the advertiser requests a new remarketing campaign. As another example, the target audience form 600 can allow the advertiser 208 to select from a number of previously stored criteria or from the most frequent chosen criteria by the advertiser 208. Alternatively, the default criteria associated with the selectable filter options 626 may be independent of the advertiser 208.

In some example embodiments, the target audience form 600 can dynamically select audience filter criteria 604 to satisfy a parameter of the remarketing campaign. For example, if the advertiser 208 requires that a product remarketing campaign remarket the product to 10,000 users 211, the product remarketing system 101 can dynamically apply audience filter criteria 604 to reduce the number of users in the dynamic audience (e.g., dynamic audience membership) to 10,000 users 211. In addition, in narrowing the number of users in the dynamic audience, the product remarketing system 101 can select audience filter criteria 604 on the target audience form 600 that maximizes the likelihood that users 211 in the dynamic audience will purchase the product, such as maximizing the number of user 211 for whom the product remarketing system 101 has detected a heightened interest in the product.

In one or more example embodiments, the advertiser 208 can include audience filter criteria 604 when requesting a remarketing campaign for product. For example, the advertiser 208 can include audience filter criteria 604 in the remarketing request that targets specific users 211 of the social networking system 204. Alternatively, the advertiser 208 may provide audience filter criteria 604 to the product remarketing system 101 after sending the remarketing request, as described above. Further, the advertiser 208 can modify the audience filter criteria 604 during a remarketing campaign, for example, by adding and/or removing the selectable filter options 626 or associated criteria.

In addition, using the target audience form 600, an advertiser 208 can target a precise dynamic audience. In particular, the target audience form 600 allows an advertiser 208 to tailor remarketing campaigns to specific users 211 on the social networking system 204. For example, an advertiser 208 remarketing a perfume can target single female users, who college on the west coast, currently live in on the east coast, like the outdoors, and have an income over $70,000 per year. Further, by using the dynamic audience filtering, an advertiser 208 can manage any number of micro remarketing campaigns targeted at small groups of users 211.

In some example embodiments, an advertiser 208 can select the number of audience filter criteria 604 a user 211 must satisfy before being included in the dynamic audience. For example, an advertiser 211 may select and/or add the criterion of “manager” for the position filter option 626f, the criterion of “New York City” for the current city filter option 626i, and the criterion of “26-30” for the age range filter option 626b. The advertiser 208 can select that a user 211 meet one, two, or all three audience filter criteria 604 to be included in the dynamic audience, or which audience filter criteria 604 are required and which are preferred. For example, the advertiser 208 can select that a user 211 be 26-30, and either from New York City or a manager to be included in the dynamic audience. Alternatively, the advertiser 208 can select that a user 211 meet any two of the three criteria to be included in the dynamic audience.

As mentioned above, the target audience form 600 can include a portion displaying audience information 608. Audience information 608 can include the total number 610 of users in the dynamic audience who have a detected interest in the corresponding product. In some embodiments, the audience information 608 can also include the number of users who viewed the product 612, selected the product 614, and/or the added the product to a shopping cart 616 (collectively referred to as “other user numbers 612-616”). In addition, the audience information 608 can indicate common attributes of users 211 in the dynamic audience, as described above.

The product remarketing system 101 can update the total number of users 610 in the dynamic audience as an advertiser 208 adds and removes products and/or audience filter criteria 604. For example, for when the advertiser 208 adds a required audience filter criterion, the product remarketing system 101 can display a reduced total number of users 211 in the dynamic audience to match the number of users that meet the new audience filter criteria 604. Similarly, the product remarketing system 101 can also update the other user numbers 612-616 when a change in the audience filter criteria 604 occurs, or when a product is added or removed.

The audience information 608 can use various number schemes in displaying the total number of users 610 or the other user numbers 612-616 to an advertiser 208. For example, the audience may display a range of numbers, such as 25,000-30,000 total users 610 in the dynamic audience. Alternatively, the audience information 608 may display a rounded number of users in the dynamic audience, such as 27,500 total users 610 in the dynamic audience. Further, the audience information 608 may display the exact number of users, such as 27,523 total users 610 in the dynamic audience. In addition, the audience information 608 can determined which numbering scheme to employ based on the number itself. For example, when the number of users is below 1,000 users, the audience information 608 may display exact numbers, and when the number of users is over 1,000 users, the audience information 608 displays numbers rounded to the nearest hundred users.

The total numbers of user 610 (and the other user numbers 612-616) displayed in the audience information 608 can also change over time as the interests of users 211 in the dynamic audience change. For example, as described above, the product remarketing system 101 may remove a user 211 from the dynamic audience for a product when the user 211 purchases the product. Further, if a user 211 has not shown interest in a product for a period of time, a month for example, the product remarketing system 101 may remove the user 211 from the dynamic audience corresponding to the product. Similarly, users 211 can be added to a dynamic audience upon showing interest in the product, as described above.

In some example embodiments, the product remarketing system 101 can provide estimates when displaying the total numbers of user 610 (and the other user numbers 612-616) to an advertiser 208 in the audience information 608. For example, the product remarketing system 101 can estimate that an addition 100 users 211 will show interest in the product during the remarketing campaign. Accordingly, the product remarketing system 101 can included the estimated users 211 when displaying total numbers of user 610 (and the other user numbers 612-616) to the advertiser 208.

In one or more embodiments, the product remarketing system 101 can allow an advertiser 208 to select whether to focus on a particular group within the dynamic audience, such as users 211 who added the product to a shopping cart. Further, the product remarketing system 101 can allow an advertiser 208 to specify a percentage of the remarketing campaign to designate to a particular group. For example, as described above, an advertiser 208 can select to designate at least 50% of the remarketing campaign on users 211 who read positive users review of the product, and at least 25% to users 211 who selected the product information page for the product. In this manner, the audience information 608 can inform the advertiser 208 of the number of users in various groups (e.g., the number of users in the various groups) to assist an advertiser 208 in managing a remarketing campaign.

FIG. 7 shows a product form graphical user interface (or “GUI”) including a product advertisement form 700. An advertiser 208 can use the advertisement form 700 to specify content to include in an advertisement for a product being remarketed. As shown in FIG. 7, the advertisement form 700 can include labels associated with product information, such as “Product Name,” “URL Link,” “Description,” “Image,” “Price,” Product ID,” “Category,” etc. One or more labels can correspond to content fields 702-714. For example, the product name label can be associated with a product name text field 702.

The product remarketing system 101 can prepopulate the product advertisement form 700, or a portion thereof. For example, the product remarketing system 101 may use product information from product data 132 or from the node data 134 to populate the product advertisement form 700, as described above. The advertiser 208, however, may need to provide some fields of the product advertisement form 700. For example, an advertiser 208 may need to provide a URL link to a product, shown as field 704.

The advertiser 208 may override and customize content within the content fields 702-714. For example, the advertiser 208 may change the title or product description. Further, the advertiser 208 can modify content on the product advertisement form 700 at any time during a remarketing campaign.

In some example embodiments, the advertiser 208 may select to allow the product remarketing system 101 to customize advertisements for one or more users, as described above, for example, by selecting a corresponding checkbox 720. The checkbox 720 may be checked by default. If the advertiser 208 unchecks the checkbox 720, the product remarketing system 101 may serve the sample advertisement 722 shown on the product marketing form to all users 211 in the dynamic audience.

In one or more embodiments, the product advertisement form 700 can allow for alternative content fields. For example, the product advertisement form 700 can allow an advertiser to provide multiple images for a product. The product remarketing system 101 can then select an image to serve to a user 211 based on the use profile of the user 211, as described above. Further, the advertiser 208 may provide multiple titles, or product descriptions. For example, each image the advertiser 208 provides may be associated with a corresponding title and description.

In some example embodiments, the product remarketing system 101 can prompt the advertiser 208 to provide additional product content based on common characteristics of users in the dynamic audience, as described above. For example, the product remarketing system 101 may inform the advertiser 208 that a number of user prefer the product in green and prompt the advertiser 208 to provide an image of the product in green.

The product advertisement form 700 can also include one or more sample advertisements 722. For example, the product remarketing system 101 can generate one or more sample advertisements based on the information included in the product advertisement form 700. The sample advertisements 722 may be reflect an advertisement tailored to suit one or more users 211 in a dynamic audience for the product, as described above.

To illustrate, a specific example embodiment in provided. An advertiser 208 may request a remarketing campaign for a 3 Person-3 Season Tent. The product remarketing system 101 can receive the request, determine a dynamic audience, and populate the product advertisement form 700 with corresponding product information. For example, the product remarketing system 101 can populate the product advertisement form 700 with content obtained from product data 132 and/or node data 134 within a storage manager 120, as described above. For instance, the product remarketing system 101 can populate the product name, description, price, etc. Further, the product remarketing system 101 can present the populated product advertisement form 700 to the advertiser 208 to allow the advertiser 208 to modify the product information.

The product remarketing system 101 can also generate a sample advertisement 722 based on user profile data 122 for a user 211 within the audience for the 3 Person-3 Season Tent. Thus, the sample advertisement 722 may represent only one potential advertisement for the 3 Person-3 Season Tent that may be served to users 211 in the dynamic audience out of a number of potential advertisements. As described above, the product remarketing system 101 may display a number of sample advertisements to the advertiser 208 based on user profile data 122 for a users 211 within the dynamic audience for the 3 Person-3 Season Tent.

As shown in FIG. 7, the sample advertisement 722 may include the product title (e.g., 3 Person-3 Season Tent), an image of the tent, and the price of the tent. Alternatively, another sample advertisement may also include a brief product description. As described above, the product remarketing system 101 can tailor each remarketing advertisement to a user 211 (or a group of users 211) within a dynamic audience to provide the greatest likelihood that users 211 will select the remarketing advertisement and purchase the product.

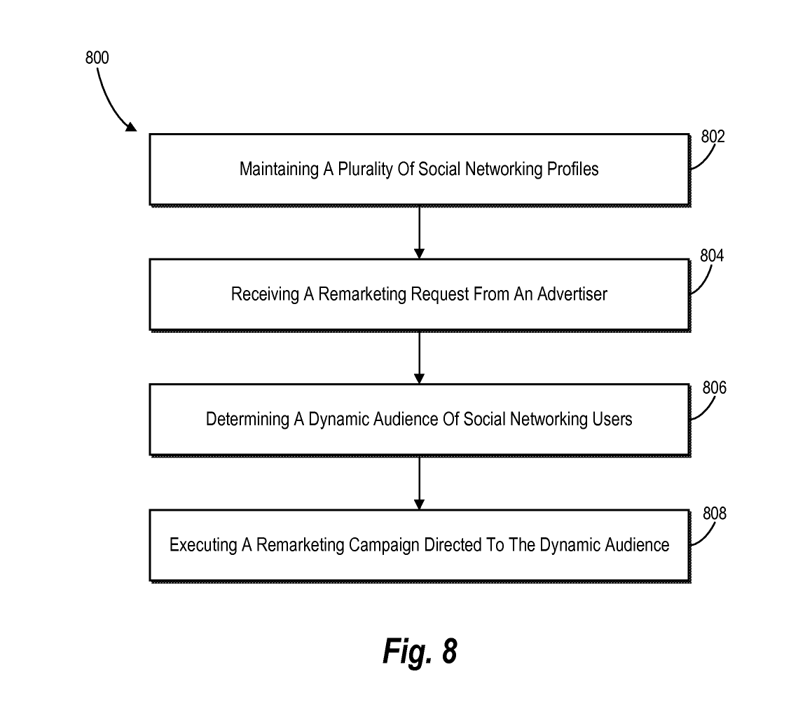

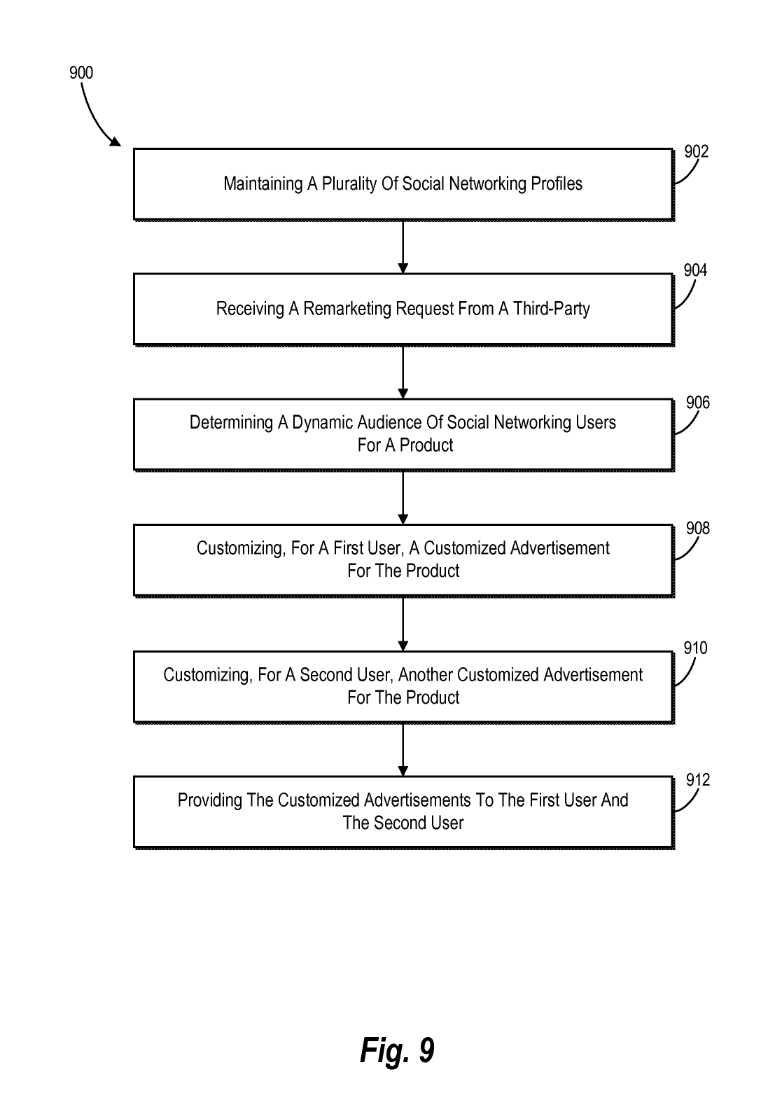

FIGS. 1-7, the corresponding text, and the examples, provide a number of different systems and devices for facilitating purchases of commerce applications. In addition to the foregoing, one or more embodiments can be described in terms of flowcharts comprising acts and steps in a method for accomplishing a particular result. For example, FIGS. 8-9 illustrate flowcharts of exemplary methods in accordance with one or more embodiments.

FIG. 8 illustrates a flowchart of an exemplary method 800 for remarketing a product to a dynamic audience 503 on a social networking system 204. The method 800 may include an act 602 of maintaining a plurality of social networking profiles (e.g., stored as user profile data 122). In particular, act 802 can comprise maintaining a plurality of social networking profiles, each social networking profile associated with a user of a social networking system and comprising personal information associated with the user (e.g., user information 124), social networking activity data 126 representing activity of the user within the social network system, and external activity data (e.g., third-party content activity data 128) representing activity of the user outside of the social networking system. As described above, a social networking system can maintain a number of social networking profiles (e.g., user profiles). Each social networking profile can correspond to a social networking user on the social networking system 204. Further, a social networking profile can include user information 124, social networking activity data 126, and third-party content activity data 128. In some example embodiments, a profile manager 112 can manage social networking profiles, which are stored in a storage manager 120.

The method 800 may also include an act 804 of receiving a remarketing request from an advertiser 208. In particular, act 804 can comprise receiving, from an advertiser 208, a request to remarket a product on the social networking system 204. In one or more embodiments, for example, an advertiser 208 can request to remarket one or more products on the social networking system 204, in any suitable manner, as described herein. For example, a remarketing manager 114 can receive and process a remarketing request.

The method 800 may further include an act 806 of determining a dynamic audience 503 of social networking users. In particular, act 806 can comprise determining, based on the plurality of social networking profiles, a dynamic audience 503 of users of the social networking system 204 that are associated with the product. For example, the profile manager 112 and/or an audience manager 116 can analyze each user's social networking profile to determine an interest level and/or association with one or more products identified in the remarketing request. In addition, the audience manager 116 may determine to include social networking users associated with the one or more products identified in the remarketing request in the dynamic audience, in any suitable manner, as described herein.

The method 800 may also include an act 808 of executing a remarketing campaign directed to the dynamic audience 503. For example, as described above, an advertisement customizer 118 can create customized advertisements for users in the dynamic audience 503 based on product information and user profile data 122. Advertisements customized for a user (or a group of users) can be served to the user (or group of users), in any suitable manner, as described herein.

Referring now to FIG. 9, FIG. 9 illustrates a flowchart of another exemplary method 900 for remarketing a product to a dynamic audience 503 on a social networking system 204. The method 900 may include an act 902 of maintaining a plurality of social networking profiles (e.g., stored as user profile data 122). In particular, act 902 can comprise maintaining a plurality of social networking profiles, each social networking profile associated with a user of a social networking system and comprising personal information associated with the user (e.g., user information 124), social networking activity data 126 representing activity of the user within the social network system, and external activity data (e.g., third-party content activity data 128) representing activity of the user outside of the social networking system. As described above, a social networking system can maintain a number of social networking profiles (e.g., user profiles). Each social networking profile can correspond to a social networking user on the social networking system 204. Further, a social networking profile can include user information 124, social networking activity data 126, and third-party content activity data 128. In some example embodiments, a profile manager 112 can manage social networking profiles, which are stored in a storage manager 120.

The method 900 may also include an act 904 of receiving a remarketing request from a third-party. In particular, act 804 can comprise receiving, from a third-party, a request to remarket a product on the social networking system 204. In one or more embodiments, for example, the third-party may be an advertiser 208 requesting to remarket one or more products on the social networking system 204, in any suitable manner, as described herein. For example, a remarketing manager 114 can receive and process a remarketing request.

The method 900 may further include an act 906 of determining a dynamic audience 503 of social networking users for a product. In particular, act 906 can comprise determining, based on the plurality of social networking profiles, a dynamic audience 503 of users of the social networking system 204 that are associated with the product. For example, the profile manager 112 and/or an audience manager 116 can analyze each user's social networking profile to determine an interest level and/or association with a product identified in the remarketing request. In addition, the audience manager 116 may include users in a dynamic audience 503 who are associated with the product identified in the remarketing request, in any suitable manner, as described herein.

The method 900 may also include an act 908 of customizing, for a first user, a customized advertisement for the product. In particular, act 908 can comprise customizing, for the first user, a first customized advertisement for the product based on the social networking profile for the first user. For example, as described above, an advertisement customizer 118 can create a customized advertisement for a first user in the dynamic audience 503 based on product information for the product (e.g., stored as product data 132 or received from the advertiser 208) and the first user's user profile data 122, in any suitable, as described herein.

In addition, the method 900 may include an act 910 of customizing, for a second user, another customized advertisement for the product. In particular, act 910 can comprise customizing, for the second user, a second customized advertisement for the product based on the social networking profile for the second user. For example, as described above, the advertisement customizer 118 can create another customized advertisement for a second user in the dynamic audience 503 based on the product information for the product (e.g., stored as product data 132 or received from the advertiser 208) and the second user's user profile data 122, in any suitable, as described herein.

The method 900 may further include an act 912 of providing the customized advertisements to the first user and the second user. In particular, act 912 can comprise providing the first customized advertisement to the first user and providing the second customized advertisement to the second user. For example, the product remarketing system 101 can provide the customized advertisements to client devices 202 associated with the first user and the second user, in any suitable manner, as described herein. For instance, the client device 202 associated with the first user can serve the advertisement customized for the first user to the first user. Similarly, the client device 202 associated with the second user can serve the advertisement customized for the second user to the second user.

One or more embodiments may comprise or utilize a special purpose or general-purpose computer including computer hardware, such as, for example, one or more processors and system memory, as discussed in additional detail below. Embodiments may also include physical and other computer-readable media for carrying or storing computer-executable instructions and/or data structures. In certain particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, example embodiments can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of one or more embodiments. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the one or more embodiments may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. One or more embodiments may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Example embodiments can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that the product remarketing system 101, 201, 301, 401, and 501; client devices 202, 302, and 402; social networking systems 204, 304, and 404; third-party servers 206, 306, and 406; and advertiser 208 and 508 can each comprise implementations of the data-computing device 1000. As shown by FIG. 10, the computing device can comprise a processor 1002, memory 1004, a storage device 1006, an I/O interface 1008, and a communication interface 1010. While an exemplary computing device 1000 is shown in FIG. 10, the components illustrated in FIG. 10 are not intended to be limiting. Additional or alternative components may be used in other embodiments. Furthermore, in certain embodiments, a computing device 1000 can include fewer components than those shown in FIG. 10. Components of computing device 1000 shown in FIG. 10 will now be described in additional detail.

In particular, embodiments, processor(s) 1002 includes hardware for executing instructions, such as those making up a computer program. As an example and not by way of limitation, to execute instructions, processor(s) 1002 may retrieve (or fetch) the instructions from an internal register, an internal cache, memory 1004, or a storage device 1006 and decode and execute them. In particular embodiments, processor(s) 1002 may include one or more internal caches for data, instructions, or addresses. As an example and not by way of limitation, processor(s) 1002 may include one or more instruction caches, one or more data caches, and one or more translation lookaside buffers (TLBs). Instructions in the instruction caches may be copies of instructions in memory 1004 or storage 1006.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example and not by way of limitation, storage device 1006 can comprise a non-transitory storage medium described above. The storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to the computing device 1000. In particular embodiments, storage device 1006 is non-volatile, solid-state memory. In particular embodiments, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The computing device 1000 also includes one or more input or output (“I/O”) devices/interfaces 1008, which are provided to allow a user to provide input to, receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008. The touch screen may be activated with a stylus or a finger.

The I/O devices/interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 1008 is configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. In any event, the communication interface 1010 can provide one or more interfaces for communication (such as, for example, packet-based communication) between the computing device and one or more other computing devices 1010 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

This disclosure contemplates any suitable network and any suitable communication interface 1010. As an example and not by way of limitation, computing device 1010 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computing system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 1010 may include any suitable communication interface 1010 for any of these networks, where appropriate.

The computing device 1000 can further include a bus 1012. The bus 1012 can comprise hardware, software, or both that couples components of computing device 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, a social-networking system (e.g., the social network system provided by Facebook, Inc.™. may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third-party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social-networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars, and events, gaming, instant messaging, and advertising. For example, the social-networking system may also include media sharing capabilities. Also, the social-networking system may allow users to post photographs and other multimedia files to a user's profile page (typically known as “wall posts” or “timeline posts”) or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similarly to events, the calendar entries may include times, dates, locations, and identities of other users.

FIG. 11 illustrates an example network environment of a social-networking system. In particular embodiments, a social-networking system 1102 may comprise one or more data stores. In particular embodiments, the social-networking system 1102 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social-networking system 1102 may comprise one or more computing devices (e.g., servers) hosting functionality directed to operation of the social-networking system. A user of the social-networking system 1102 may access the social-networking system 1102 using a client device such as client device 1106. In particular embodiments, the client device 1106 can interact with the social-networking system 1102 through a network 1104.

The client device 1106 may be a desktop computer, laptop computer, tablet computer, personal digital assistant (PDA), in- or out-of-car navigation system, smart phone or other cellular or mobile phone, or mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over a network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access the social-networking system 1102.

While these methods, systems, and user interfaces utilize both publicly available information as well as information provided by users of the social-networking system, all use of such information is to be explicitly subject to all privacy settings of the involved users and the privacy policy of the social-networking system as a whole.

In the foregoing specification, one or more embodiments have been described with reference to specific exemplary embodiments thereof. Various embodiments are described with reference to details discussed herein, and the accompanying drawings illustrate the various embodiments. The description above and drawings are illustrative of one or more examples, and are not to be construed as limiting. Numerous specific details are described to provide a thorough understanding of various embodiments.

One or more embodiments may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the disclosure is, therefore, indicated by the appended claims rather than by the foregoing description. All changes that come within the meaning and range of equivalency of the claims are to be embraced within their scope.

What is claimed is:

1. A method comprising:
maintaining, using at least one processor, a plurality of social networking profiles, each social networking profile associated with a user of a social networking system and comprising personal information associated with the user, social networking activity data representing activity of the user within the social network system, and external activity data representing activity of the user outside of the social networking system;
receiving, from an advertiser, a request to remarket a product on the social networking system;
determining, based on the plurality of social networking profiles, a dynamic audience of users of the social networking system that are associated with the product; and
executing a remarketing campaign directed to the dynamic audience.

2. The method of claim 1, further comprising:
generating, for one or more users in the dynamic audience, an advertisement for the product based on social networking profiles of the one or more users; and
providing the advertisement to the one or more users.

3. The method of claim 2, further comprising:
providing another advertisement to the one or more users in the dynamic audience;
monitoring the advertisement and the another advertisement;
determining whether the one or more users in the dynamic audience prefer the advertisement or the another advertisement;
identifying a preference attribute from the advertisement preferred by the user; and
augmenting the social networking profile of the one or more users in the dynamic audience with the preference attribute.

4. The method of claim 2, further comprising receiving product information for the product from an open graph node within the social networking system.

5. The method of claim 1, wherein the advertiser has previously marketed the product to the one or more users outside of the social networking system.

6. The method of claim 1, further comprising receiving, from the advertiser, input corresponding to the selection of the dynamic audience.

7. The method of claim 6, wherein the input comprises one of demographics, geography, gender, age, economic status, employment, views, politics, or education.

8. The method of claim 1, wherein the dynamic audience comprises users of the social networking system that have viewed, selected, shared, previewed, or interacted with the product, or added the product to a virtual shopping cart.

9. The method of claim 1, wherein the external activity data represents e-commerce activity by the one or more users with one or more third parties.

10. The method of claim 1, further comprising using a tracking element to detect an interest level in the product for a user of the social networking system when the user is at least viewing the product outside of the social networking system; and
updating the external activity data within a social networking profile of the user to reflect the interest level in the product.

11. The method of claim 10, further comprising updating the dynamic audience to include the user based on the user interest in the product.

12. The method of claim 1, further comprising removing a user of the social networking system from the dynamic audience when the user purchases the product.

13. The method of claim 1, further comprising providing, to the advertiser, a number of users in the dynamic audience.

14. The method of claim 13, further comprising providing, to the advertiser, a number of users within the dynamic audience that have viewed the product, a number of users within the dynamic audience that have selected the product, and a number of users within the dynamic audience that have added the product to a virtual shopping cart.

15. The method of claim 1, further comprising providing, to the advertiser, one or more attributes of the dynamic audience.

16. The method of claim 14, wherein the one or more attributes include at least one attribute common to a plurality of users in the dynamic audience, the common attribute not being the plurality of users association with the product.

17. The method of claim 14, wherein the common attribute relates to at least one of demographics, geography, gender, age, economic status, employment, education, interests, relationships, living, views, or politics.

18. A method comprising:
maintaining, using at least one processor, a plurality of social networking profiles, each social networking profile associated with a user of a social networking system and comprising personal information associated with the user, social networking activity data representing activity of the user within the social network system, and external activity data representing activity of the user outside of the social networking system;
receiving, from a third-party, a request to remarket a product on the social networking system;
determining, based on the plurality of social networking profiles, a dynamic audience of users of the social networking system that are associated with the product, the dynamic audience including a first user and a second user;
customizing, for the first user, a first customized advertisement for the product based on the social networking profile for the first user;
customizing, for the second user, a second customized advertisement for the product based on the social networking profile for the second user;
providing the first customized advertisement to the first user; and
providing the second customized advertisement to the second user.

19. The method of claim 17, wherein the first customized advertisement includes a first image of the product based on the social networking profile for the first user and the second customized advertisement includes a second image of the product based on the social networking profile for the second user, the first image differing from the second image.

20. A system comprising:
at least one processor; and
at least one non-transitory computer readable storage medium storing instructions thereon that, when executed by the at least one processor, cause the system to:
maintain, using at least one processor, a plurality of social networking profiles, each social networking profile associated with a user of a social networking system and comprising personal information associated with the user, social networking activity data representing activity of the user within the social network system, and external activity data representing activity of the user outside of the social networking system;
receive, from an advertiser, a request to remarket a product on the social networking system;
determine, based on the plurality of social networking profiles, a dynamic audience of users of the social networking system that are associated with the product; and
execute a remarketing campaign directed to the dynamic audience.
